(19) United States
(12) Patent Application Publication
(10) Pub. No.: US 2010/0037248 A1
(43) Pub. Date: Feb. 11, 2010

(54) SYSTEM AND METHOD FOR DYNAMIC PRICING OF MOBILE TV CONTENT

(75) Inventors: CHARLES N. LO, San Diego, CA (US); Donald W. Gillies, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/536,194

(22) Filed: Aug. 5, 2009

Related U.S. Application Data
(60) Provisional application No. 61/086,748, filed on Aug. 6, 2008.

(51) Int. Cl. H04N 7/16

(52) U.S. Cl. 725/1

(57) ABSTRACT

Methods and systems enable mobile TV broadcast service providers to allow dynamic pricing for access to broadcast programs. A server within a mobile TV broadcast network may negotiate the price for accessing a broadcast program with individual users via their mobile devices. The server may receive requests to access broadcast programs with price offers from mobile devices. The server may respond to price offers by accepting the price offer or by making a counter offer until a mutually agreeable price is identified. Alternatively, the server may implement any of a number of types of auctions for access rights to broadcast programs. Similar to negotiable dynamic pricing methods, once purchase requests for viewing access to broadcast content programs at current asking prices are accepted, the mobile TV broadcast service provider may transmit the appropriate decryption keys to the users who made accepted offers or bids.

### RELATED APPLICATIONS

This application claims the benefit of priority to U.S. Provisional Application No. 61/086,748 entitled “System and Method for Negotiating Price of Mobile TV Content” filed Aug. 6, 2008, the entire contents of which is hereby incorporated by reference.

### BACKGROUND

Wireless communication technologies have seen explosive growth over the past few years. This growth has been fueled by wireless services providing freedom of movement to the mobile public, and cutting the tether to hardwired communication systems. In addition, the increasing quality and speed of voice and data communications over the wireless medium has attracted additional users. As a result of these service enhancements, the popularity of wireless services is expected to continue to grow rapidly.

A recent addition to wireless communication technologies has been the ability to broadcast programs to mobile users. Mobile broadcast users can view mobile editions of news, entertainment, sports, business, and other programming using their cell phone or other wireless devices. These broadcast systems have seen significant increase in usage and availability worldwide. At present, mobile TV broadcast service providers set a static price for viewing access to a broadcast content program. Users elect to subscribe to the broadcast content program or not based upon the static price for viewing access.

### SUMMARY

The various embodiments herein provide methods and systems which allow mobile TV broadcast service providers to maximize revenue generating opportunities by dynamically pricing viewing access to broadcast content programs. In an embodiment, mobile TV broadcast service providers through a server may negotiate the viewing access fee with individual mobile devices. The mobile TV broadcast service provider's server may request a static fee for viewing access to broadcast content. After a predetermined time has elapsed, the server may broadcast a dynamic pricing message to a plurality of mobile device indicating that viewing access to a broadcast program is available through dynamic pricing. The server may then receive a dynamic price offer from an individual mobile device and negotiate with the mobile device until a mutually agreeable fee is identified. Once a mobile device and the server mutually agree to a fee for viewing access, the server may transmit (or direct the transmission of) the appropriate decryption keys to the user which will provide the mobile device with sufficient viewing access to complete viewing of the desired program. In other alternative embodiments, the mobile TV broadcast service provider's server may operate various auctions which may attract additional mobile devices to subscribe to broadcast content by providing multiple price points at which different users may be willing to subscribe to a broadcast content program.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a block diagram illustrating a mobile TV broadcast communication system.

FIG. 2 is a block diagram of a mobile TV broadcast system.

FIG. 3 is a flow diagram of an embodiment price negotiation method.

FIG. 4 is a flow diagram of an method to set up the content manager server for acceptance of dynamic pricing.

FIG. 5 is a flow diagram of a broadcast content price negotiation method.

FIG. 6 is a flow diagram performed by a mobile TV broadcast system of a method to transmit the appropriate decryption keys to the user's mobile device to allow viewing access to a broadcast content program.

FIG. 7 is a flow diagram of a method to transmit the appropriate decryption keys to the user's mobile device to allow viewing access to a broadcast content program.

FIG. 8 is a flow diagram illustrating the interaction of broadcast system elements.

FIG. 9 is an illustration of a service guide data model.

FIG. 10 is a flow diagram of a dynamic pricing method for broadcast content.

FIG. 11 is a flow diagram of a dynamic pricing method for broadcast content

FIG. 12 is a flow diagram of a dynamic pricing method for broadcast content.

FIG. 13 is a block diagram of a mobile device.

FIG. 14 is a block diagram of a server device.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

As used herein, the terms “mobile device” refers to any one or all of cellular telephones, personal data assistants (PDA's), palm-top computers, lap-top computers, wireless electronic mail receivers (e.g., the Blackberry® and Treo® devices), multimedia Internet enabled cellular telephones (e.g., the Blackberry Storm®), Global Positioning System (GPS) receivers, wireless gaming controllers, and similar personal electronic devices which include a programmable processor and memory and mobile TV broadcast receiver circuitry for receiving and processing mobile TV broadcast transmissions.

The word “broadcast” is used herein to mean the transmission of data (information packets) so that it can be received by a large number of receiving devices simultaneously. Examples of a broadcast message are traditional pager networks, mobile television service broadcast signals, including content broadcasts (content flow) and overhead information broadcasts (overhead flow) such as metadata messages. The term “unicast network” is used herein to refer to communication networks which transmit data to a single destination. Examples of a unicast network include WiFi and cellular data communication networks. Examples of unicast transmissions include simple message service (SMS), multimedia message service (MMS), and electronic mail messages as may be carried via a cellular telephone data communication network.

The word “content providers” is used herein to refer to companies which provide video, audio, text, graphics, multimedia, website and other data that is broadcast over a mobile television system. The term “mobile TV broadcast service providers” is used herein to refer to those entities which broadcast mobile television signals. Typically, mobile TV broadcast service providers receive broadcast content from the content providers and relay it to users over a broadcast network.

The growing popularity of mobile television (TV) has provided new sources of revenue for content providers and mobile TV broadcast service providers who can use the new medium to reach additional consumers. New revenue models include subscription-based sales of mobile television access, Pay-per-view (PPV) or Pay-per-time (PPT) mobile television access. For example, mobile TV broadcast service providers can generate revenue from their service by selling subscriptions to users for viewing access to individual broadcast content programs or bundled packages of multiple broadcast content programs (e.g., professional football season pass). By individually encrypting broadcast content programs and providing users with the necessary decryption keys only when payment for a subscription is received or can be otherwise assured, mobile TV broadcasters can control which users may obtain viewing access to certain broadcast content programs. In a conventional system, the price charged for each subscription is static. The static price may be chosen to attract the most potential subscribers while allowing the mobile TV broadcast service provider to recoup the fixed costs associated with the broadcast of the program as well as some margin of profit. Choosing an appropriate static price may be difficult as the pool of potential subscribers is likely to have varying degrees of interest in the broadcast content program.

The degree of interest an individual potential subscriber may have in a broadcast content program and thus the price the individual potential subscriber may be willing to pay for viewing access to the broadcast content program may vary as a function of time until actual broadcast. For example, a mobile TV broadcast service provider may begin to advertise viewing access to a sports event well in advance of the actual event and broadcast. Several weeks before the event there may be little interest in the event. Consequently, in order to attract as many subscribers as possible a relatively low static price may be chosen. However, as the hype surrounding the live event builds, interest in viewing the event may peak immediately preceding the broadcast. Also, the more dynamic an event is the more interest in the event may exceed expectation (e.g., sporting events where background stories regarding participants have increased interest in the event), and thus cause difficulty in setting a pay-per-view price that will maximize revenues.

Certain broadcast content programs may be considered a perishable good. For example, live sporting events may be considered high value content prior to broadcast when the outcome remains unknown. Many potential subscribers may be willing to pay a premium to insure that they can view or record the event as it occurs in real time. However, as the sporting event proceeds the outcome will become less uncertain and its value to potential subscribers diminished. Any viewing access subscriptions not sold while the content has its highest value (i.e., prior to broadcast) represent lost revenue opportunities since the broadcast will consume a fixed amount of mobile TV broadcast service provider resources (server storage and processing, OA&M and billing, airlink bandwidth, etc.) regardless of the number of subscribers.

In some environments the broadcast network may be treated as an adjunct to the stadium venue. In this situation, the number of “seats” for broadcast viewing may be limited, just as in a stadium, because of contracts with the event organizers. In this scenario, traditional methods (such as a Dutch Auction) may be used to obtain the highest sales prices for a finite number of seats.

For the foregoing reasons it would be advantageous for mobile TV broadcast service providers to implement a form of dynamic pricing for viewing access to at least some of its broadcast content programs. A dynamic pricing method may allow mobile TV broadcasters to maximize revenue generating opportunities for some programming by allowing the market to dictate an appropriate pricing for viewing access to a broadcast content program.

Dynamic pricing may be implemented, for example, by allowing the user to negotiate a price for viewing access with the mobile TV broadcast service provider. In this manner, the mobile TV broadcast service provider may be able to maximize the number of subscribers to a particular program by appealing to a wide variety of subscribers and their individual varying levels of interest in a program. In addition, the mobile TV provider may be able to maximize the price received for viewing access by allowing those most interested in the program to pay more while still attracting subscribers with marginal interest. Potential subscribers may be allowed to offer a price that they are willing to pay for viewing access to the broadcast content program. The mobile TV broadcast service provider may then accept or reject such offers. Additionally, the mobile TV broadcast service provider may be configured to provide a counter offer.

Currently, the Open Mobile Alliance Broadcast Working Group (OMA BCAST) specification define a set of standardized service provisioning messages (e.g., for subscription/unsubscription, price inquiry, account information retrieval, etc.). In addition, the OMA BCAST Service Guide (SG) specification indicates that when the price associated with a particular broadcast content is absent in the “Purchase Data” portion of the guide, it implies that the purchase price of the broadcast content is negotiable with the user in a future purchase transaction. The various embodiments disclosed herein provide systems and methods to support dynamic pricing models for broadcast mobile TV content such as negotiable pricing schemes.

Price negotiation methods need not imply a price reduction, but may also allow the acceptance price to be higher than an initial price. This might be implemented, for example, after a nominal purchasing time window expires, giving potential subscribers an opportunity to subscribe to broadcast content at the last minute. In this manner, mobile TV broadcasters could charge a “late” fee associated with broadcast content beyond the normal purchase period. Such last-minute fee increases may be justified since enabling last minute purchasing would increase the costs associated with OA&M and billing resources. Alternately, in some cases last minute purchasing cannot be accommodated because the extreme demand may turn the air interface itself into a bottleneck for making subscription requests. Such a pricing model may also be advertised as offering a discounted price to early purchasers.

Other dynamic pricing may also be implemented. For example, mobile TV broadcast service providers may implement auctions which allow users to submit bids indicating the price they are willing to pay for viewing access. Different variations of auctions may be implemented, which may allow a mobile TV broadcaster to attract the maximum number of subscribers while allowing users to pay according to their relative level of interest in a particular program.

A number of different mobile TV layer technologies and related standards are available or contemplated in the future, all of which may implement and benefit from the various embodiments. Such standards include Open Mobile Alliance Mobile Broadcast Services Enabler Suite (OMA BCAST), MediaFLO, Digital Video Broadcast IP Datacasting (DVB-IPDC), and China Multimedia Mobile Broadcasting (CMMB). While the broadcast formats and terminology vary among the different mobile TV service standards, they all employ metadata transmissions to enable mobile devices to receive selected content and inform users of programs and content available for viewing or download. To avoid confusion regarding particular broadcast standards, the generic terms content flow, overhead flow, and metadata messages are used herein to describe the various embodiments.

Typically, mobile TV broadcast transmissions are encrypted so that the access to programming can be sold on a subscription, pay-per-play or pay-per-view basis. Thus, when the various embodiments allow the user and mobile TV broadcast service provider to mutually agree upon a price for a particular broadcast content, a decryption key may be transmitted to the user's mobile device to enable viewing. Typically, mobile TV broadcast services utilize unicast communication networks, such as a customer's cellular telephone data service, to communicate subscription messages to/from particular customer mobile devices, and a separate broadcast network to broadcast the mobile television programming to all mobile devices. In overview, a mobile TV broadcast service provider can transmit messages which include information that enables a mobile device to generate the decryption keys needed to receive a particular broadcast. Decryption keys may be configured to expire after a predetermined amount of time in order to enable pay-per-view type services, as well as limit the economic impact of decryption keys falling into the public domain. Additionally, the messages providing decryption keys may include service limitation parameters that may be used to limit received broadcast services to particular programs, channels, or other market segmentations.

By way of example, the OMA BCAST standard uses a long-term key message (LTKM) that is transmitted to mobile devices via a unicast network to provide a restricted access key. The restricted access key is used by the mobile device to decrypt a Traffic Encryption Key (TEK) contained in encrypted form within Short Term Key Messages (STKMs) which are broadcast regularly over the broadcast network. When decrypted, the TEK enables the mobile device to decrypt the encrypted broadcast content stream for a short period of time (e.g. two minutes, for example). When a TEK expires access to the encrypted broadcast content will terminate unless a new TEK is obtained. To enable customers to view entire programs, STKM messages are broadcast on a sequential basis so that new TEKs can be obtained from those STKMs using the long-term key obtained from the LTKM.

The various embodiments are described below using OMA BCAST standard terminology and message names as an illustrative example. The other mobile broadcast standards use similar messaging structures differing in message names and details that are not critical to the various embodiments. For example, DVB-IPDC uses Key Management Messages (KMMs) in a manner similar to the LTKM of the OMA BCAST standard, Key Stream Messages (KSM) in a manner similar to the STKM of the OMA BCAST standard, and TEKs in a manner similar to the TEKs of the OMA BCAST standard. Similarly, MediaFLO and CMMB use Encryption Management Messages (EMMs) in a manner similar to the LTKM of the OMA BCAST standard, Encryption Codeword Messages (ECM) in a manner similar to the STKM of the OMA BCAST standard, and Codewords (CW) in a manner similar to the TEKs of the OMA BCAST standard. Thus, the following descriptions are provided as an illustrative example, and are not intended to limit the scope of the embodiments or the claims to the OMA BCAST standard. For ease of reference, longer term rights management messages will be referred to herein as long term decryption key messages or LTKM, the shorter term decryption key delivery messages will be referred to herein as short term decryption key messages or STKM, and the decryption key used to decrypt encrypted broadcast content will be referred to herein as the content decryption key or TEK.

In a conventional mobile TV broadcast system, users subscribe to a mobile TV broadcast service provider for viewing access to a particular broadcast content and pay a static price for the viewing access. Once verification of payment for the subscription has been made, the mobile TV broadcast service provider transmits a LTKM or STKM enabling the user with access to view the program. Typically, the static price of the viewing access is listed in the service guide indicating other information regarding the broadcast content (e.g., channel, time, duration, etc.).

Mobile TV broadcast services enable mobile devices to be self-contained by broadcasting information about the programs and content that will be broadcast in the future via a portion of broadcast transmissions dedicated to carrying overhead information (referred to herein as the “overhead flow” or the “content description flow”) which is separate from the portion of the broadcast transmissions that carry the content (referred to herein as “content flow”). Mobile devices can also process this metadata to provide users with an electronic viewing guide. Such an electronic viewing guide, which is known in some mobile TV formats as a “service guide” (SG) or “electronic service guide” (ESG), is a viewable program guide similar to that available on cable and satellite television systems. These service guides typically contain fixed pricing information which informs potential subscribers (also referred to as users) of the cost to view the broadcast content.

The content metadata referred to herein as the “service guide” may be transmitted in an overhead flow which occupies a low bandwidth portion of the mobile TV broadcast signal for carrying overhead information like the program and content metadata. In contrast to this overhead flow, programs and content are typically broadcast using high bandwidth portions of the broadcast signal, which are collectively referred to herein as the “content flow.”

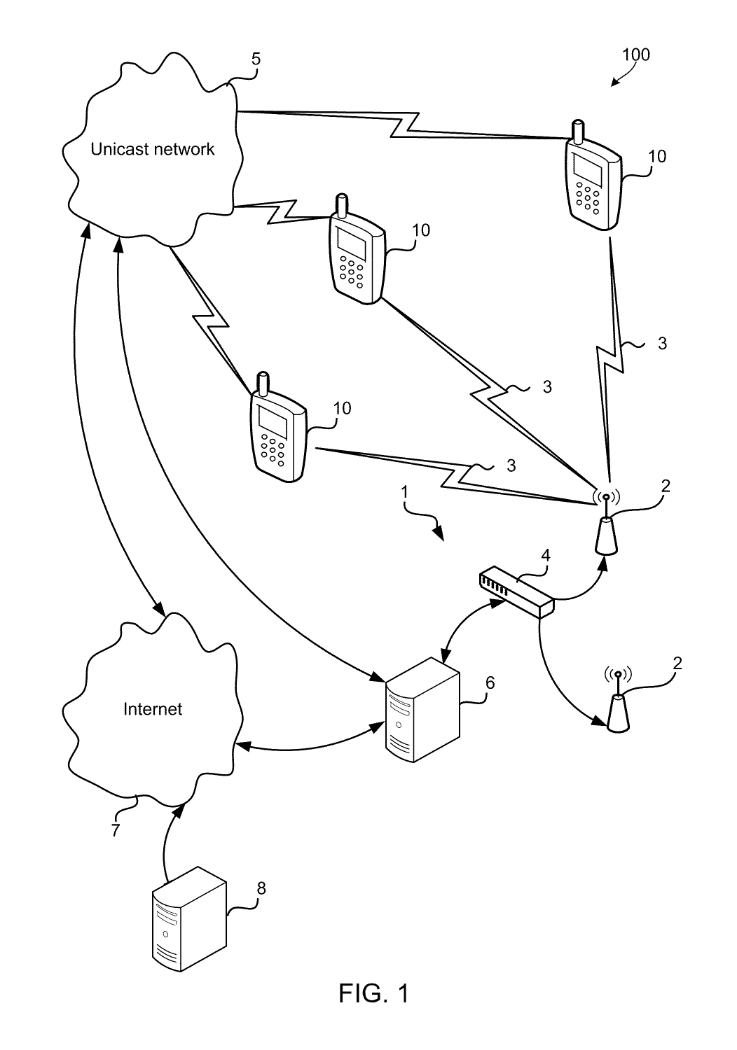

Example components of a typical mobile TV broadcast system 100 are illustrated in FIG. 1. A mobile TV broadcast network 1 typically includes a plurality of broadcast transmitters 2 controlled by a mobile broadcast network control center 4. The mobile TV broadcast network 1 broadcasts content from the broadcast transmitters 2 as mobile broadcast transmissions 3 for reception by mobile devices 10. Within the mobile broadcast network control center 4 will typically be one or more content manager servers 6 which may be configured to manage the scheduling of content broadcasts, generation of electronic service guides and other metadata regarding the content broadcasts, and generation of metadata messages for broadcast via the overhead flow of the mobile TV broadcast network 1. One or more content manager servers 6 may also include connections to an external network, such as the Internet 7, through which the content manager server 6 may receive content feeds from content provider servers 8. One or more content manager servers 6 may be configured according to the various embodiments to receive content from content provider servers 8, determine information about the received content such as the fixed nominal fee for viewing access to the broadcast content. In addition, the content manager server 6 may be tasked with receiving broadcast content program requests. Such requests may be made by users in conjunction with either a static pricing model or a dynamic pricing model. While FIG. 1 illustrates a content manager server 6 performing the functions of content management as well as subscription management, in alternative embodiments multiple servers may be employed to perform these functions. Thus, in these alternative embodiments an additional subscription manager server (not shown) may be provided in conjunction with the content manager server 6. The content manager server 6 may be tasked with all content management functions, while the subscription manager server may be tasked with receiving content program requests. Such requests may be made by users in conjunction with either a static pricing model or a dynamic pricing model.

To enable users to request broadcast programs, mobile devices 10 may communicate with the content manager server 6 via a unicast network 5. Alternatively, mobile devices 10 may communicate with the content manager 6 via a unicast network 5 and Internet 7. For example, the need to communicate with the content manager 6 via both a unicast network and Internet 7 may occur when a user is located outside of the user's home network and the user's home network subscription manager is not available. When viewing requests are accepted, the content manager server 6 may communicate with other billing servers (not shown) to facilitate the appropriate billing of individual accounts to complete the process to allow viewing access to the broadcast content program.

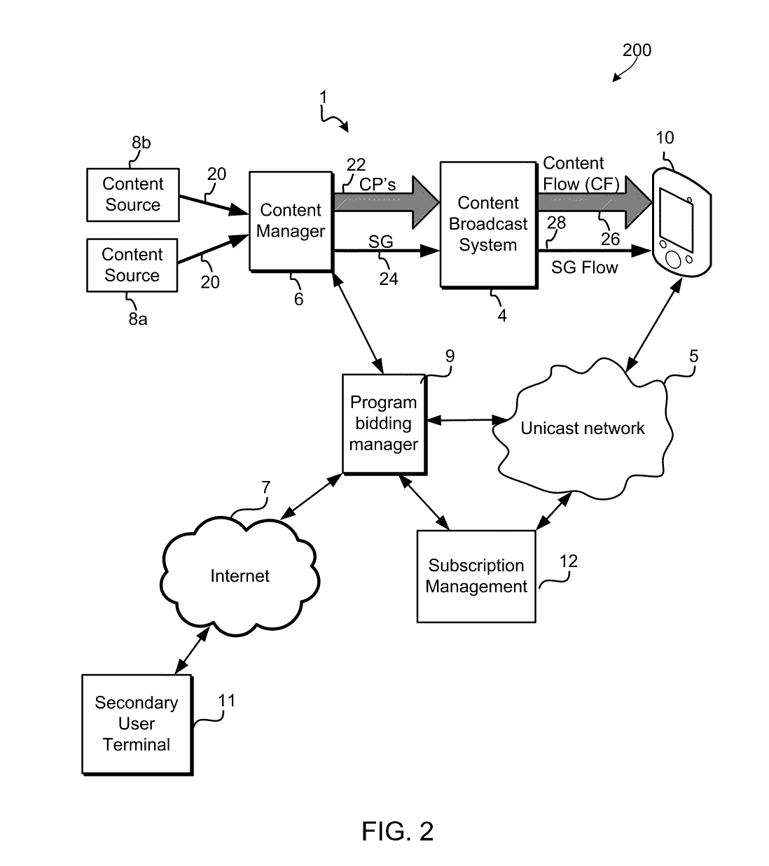

Referring to FIG. 2, viewing requests may also be made from secondary user terminals 11. For example, a user may wish to schedule the viewing of a program on a mobile device 10 from a remote computer logged into the user's account. The user may use the secondary user terminal to communicate with a program bidding manager 9 via the Internet 7. If the price negotiation is successfully completed and the viewing request is accepted, the program bidding manager 9 may direct a subscription management center 12 to transmit the necessary encryption keys to the mobile device 10 for actual viewing.

Typically, mobile TV broadcast service providers receive a variety of different programs and content from different content sources and content providers. The mobile TV broadcast service provider typically stores content in a server, schedules broadcast windows for each content, and then broadcasts the content in batches. To enable mobile devices to receive the content, the mobile TV broadcast service provider server will generate metadata messages for transmission via the overhead flow that inform mobile devices when each program or content will be transmitted and the broadcast address on which the transmission will be made. In the case of live television events (e.g., sports events, concerts), the content is transcoded before broadcast via streaming. This may incur a small latency due to the transcoding. Since the mobile TV broadcast service provider may typically know well in advance of the live television event when the live event will occur, the mobile TV broadcast service provider may still generate metadata messages for transmission via the overhead flow that inform mobile devices when each program or content will be transmitted and the broadcast address on which the transmission will be made. Mobile devices can use the information in the metadata messages to determine if any of the content has been selected by the user for stream reception or file download and, if so, determine the time to tune-in to the broadcast transmissions and the network address on which to receive the selected content.

FIG. 2 shows information flow diagram 200 illustrating message and information flows within a mobile TV broadcast network 1 according to an embodiment. As mentioned above, a mobile TV broadcast network 1 may receive content (e.g., television programs websites, serial data feeds, etc.) from a number of content sources 8a, 8b. Such content may be provided to a content manager server 6 within a mobile TV broadcast network 1 via data networks 20 (e.g., FIG. 1, Internet 7). The content manager server 6 may store such content in a database and schedule the content for broadcast. In scheduling content for broadcast, the content manager server 6 determines what will be broadcast when and on which network address. As part of scheduling, the content manager server 6 may format the content into content packages (CPs). The content manager server 6 can also determine information about the content, such as a title of the information, its source (e.g., an Internet address, URL or producer), the nature of the information (e.g., sports, news, finance, etc.), its age or date/time of creation, and the pricing of viewing access to the content. The content manager server 6 may combine the scheduled broadcast time and address with the other information regarding the content to generate content packet descriptions (CPDs) in the form of a service guide. When content is scheduled for broadcast, the content manager server 6 may provide the content packages to the content broadcast system 4 in a network dataflow 22. The service guide may be provided in a network dataflow 24. These data flows are then processed by the content broadcast system 4 into a multiplex broadcast waveform which are broadcast live by the network transmitters 2 as broadcast transmissions.

Within the broadcast transmissions there may be several different content flows (CF) 26 which are data packets carrying the broadcast content in addition to a service guide flow 28 comprising data packets carrying the content packet descriptions. Mobile devices 10 receive the broadcast transmissions and are able to separately process content flow(s) 26 and the service guide flow 28.

To facilitate dynamic pricing, each user's mobile device 10 may communicate with a program bidding manager 9 via a unicast network 5. The program bidding manager 9 may be a software module operating within the content manager server 6 or may be software operating on a separate server which is in direct communication with the content manger server 6. The program bidding manager 9 module within the content manager server 6 may be responsible for the transmission and receipt of dynamic price offers, acceptances and counteroffers to and from each individual mobile device 10.

Communications between the program bidding manager 9 module and mobile devices 10 may be via a bi-directional communication link over a unicast network 5. The bi-directional communication link may be configured to communicate voice traffic and/or data traffic among and between various devices, including each of the mobile devices 10. The bi-directional link as used by the various embodiments is not limited to a wireless link or even a particular telecommunication technology and may comprise one or more wired and/or wireless links, including one or more of a Ethernet, telephone (e.g., POTS), cable, power-line, and fiber optics systems, and/or wireless systems comprising one or more of a code division multiple access (CDMA or CDMA 2000) communication system, a frequency division multiple access (FDMA) system, a time division multiple access (TDMA) system such as GSM/GPRS (General Packet Radio Service)/EDGE (enhanced data GSM environment), a TETRA (Terrestrial Trunked Radio) mobile telephone system, a wideband code division multiple access (WCDMA) system, a high data rate (1xEV-DO or !xEV-DO Gold Multicast) system, an IEEE 802.11 system, or an orthogonal frequency division multiple access (OFDM) based system.

In operation, a service guide is generated by the content manager server 6 in the mobile TV broadcast network 1. The service guide comprises a data model that models the services, schedules, content, related purchase and provisioning data, access and interactivity data using fragments. The service guide may be as defined in the OMATS-BCAST_Services-V1_{—}0 specification from OMA.

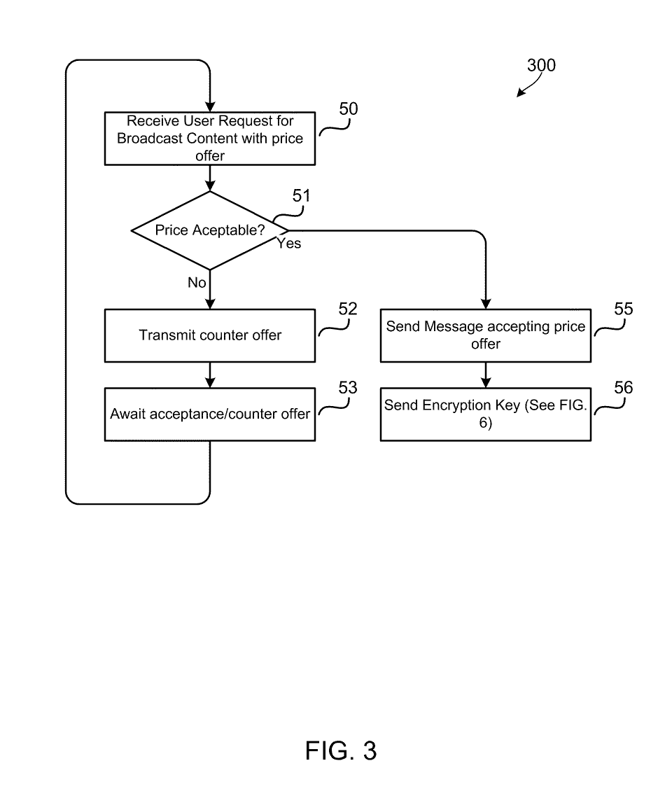

FIG. 3 is an overview process flow diagram illustrating an embodiment method 300 for conducting a dynamic price negotiation. The price negotiation process may be performed by the content manager server 6 with a program bidding manager 9 operating as a module within the content manger server 6 or as a separate server in communication with the content manager server 6. For sake of simplicity, the operation of the program bidding manager 9 will be described as a module within the content manager server 6. Operations of the program bidding manager 9 will be referred to as being performed by the content manager server 6. However, such operations may be performed by a different server within or connected to the mobile TV broadcast system.

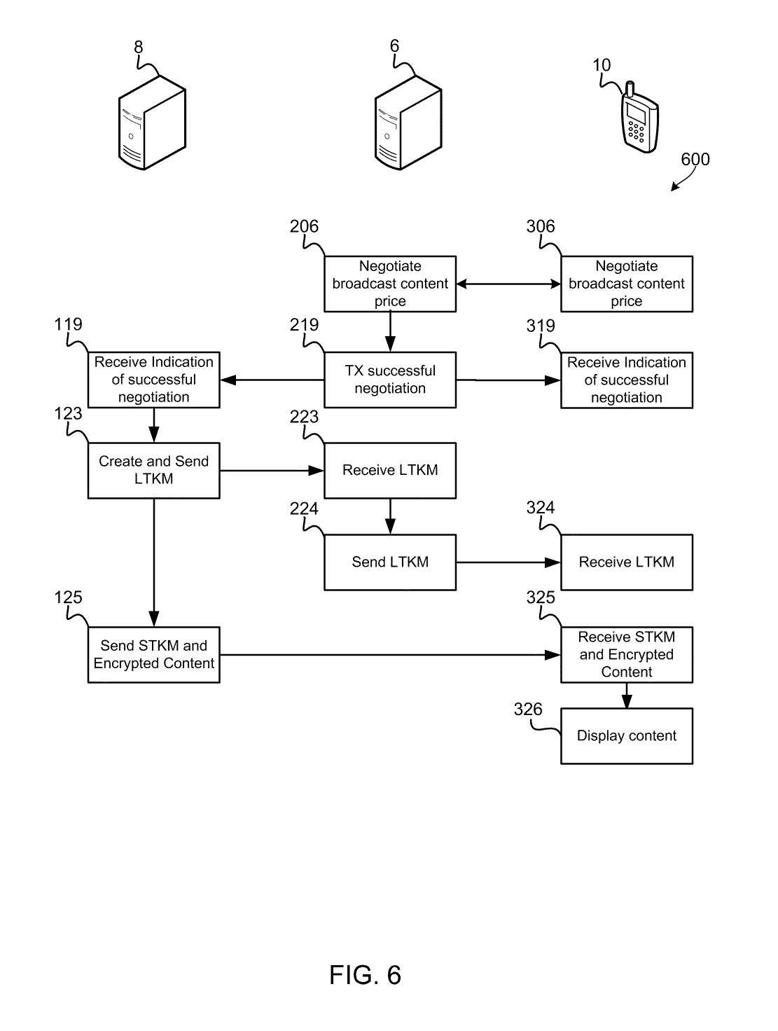

Having received the service guide, a user may determine that he is interested in viewing a particular broadcast content program. In dynamic pricing operations, the content manager server 6 may receive user dynamic price offers for a broadcast program, step 50. The content manager server 6 may evaluate the user's price offer and determine whether the price offer is acceptable, determination 51. This may be accomplished, for example, by comparing the offered price to a predetermined threshold value stored in memory, or by analyzing offered prices using an algorithm to predict a maximum revenue price. If the price offer is acceptable (i.e., determination 51=Yes), then the content manager server 6 may initiate a process to send a message to the user that the price offer is acceptable, step 55. The content manager server 6 may then send the user a decryption key which will provide the user with viewing access to the broadcast content program, step 56. The process for sending the user a decryption key is described in more detail below with reference to FIG. 6.

However, if the price offer is not acceptable (i.e., determination 51=No), the content manager server 6 may transmit a counter offer to the user via the bi-directional link on the unicast network 5, step 52. The content manager server 6 then awaits the user's response to the counter offer, step 53. If the counter offer is accepted by the user then the user's mobile device 10 may transmit an acceptance message to the content manager server 6. When the mobile device 10 receives the user's input to accept the counter offer, the mobile device 10 may generate and transmit a new dynamic price offer identifying the price offer contained in the content manager server's 6 counter offer. Upon receipt of this new dynamic price offer, the content manager server 6 will accept the new dynamic price offer as it will contain a previously acceptable price offer. Alternatively, the mobile device 10 may generate and transmit an indication to the content manager server 6 that the counter offer is acceptable. Otherwise, if the user elects to counter offer with a different price offer (i.e., a lower price offer), then the content manager server 6 receives the user request for broadcast content with the different price offer, step 50, and determines if the price offer is acceptable, determination 51.

Any of a number of negotiation algorithms may be employed by the content manager server 6 to enable dynamic price negotiations. For example, a minimum acceptable price for viewing access to a broadcast content program may be established. If the price offered by the user is below the minimum acceptable price, the difference between the minimum acceptable price and the price offered by the user may be calculated. The content manager server 6 may generate and transmit a counter offer price whereby the difference between the counter offer price and the minimum acceptable price is the same or some fraction of the difference between the minimum acceptable price and the price offered by the user. In this manner, the content manager server 6 may continue to generate and transmit counter offers until the minimum acceptable price or some price greater than the minimum acceptable price is offered and/or accepted by the user.

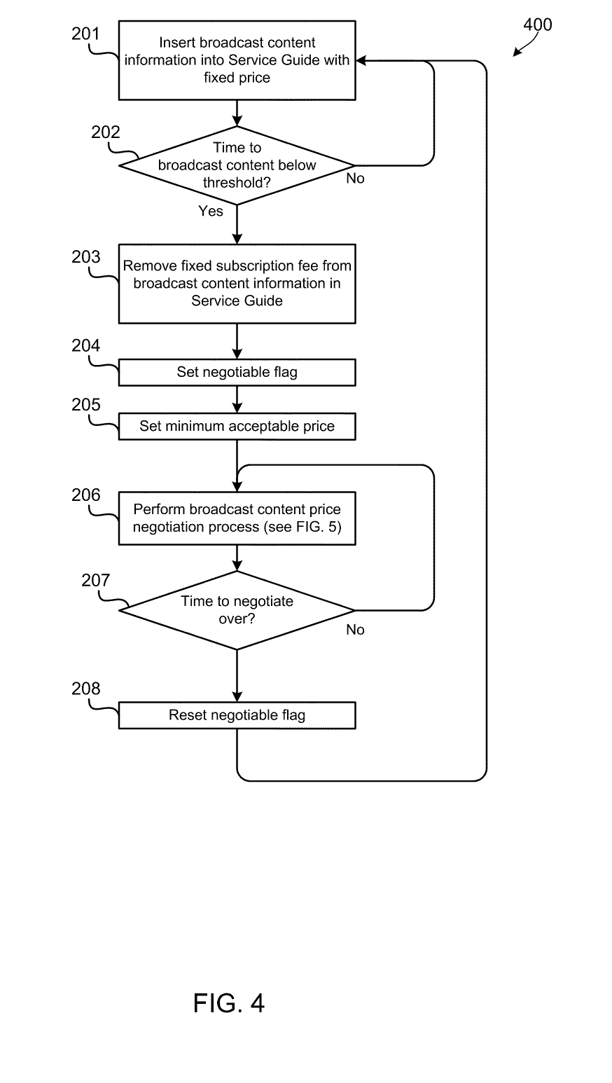

FIG. 4 is a process flow diagram illustrating an embodiment method 400 for initiating the content manager server 6 in dynamic pricing mode. As an example of the embodiment method in operation, the pay-per-view program may be the live broadcast of a sporting event. The content manager server 6 may generate content packet descriptions (CPDs) which describe the broadcast content program and include a variety of information including the static price for which viewing access will be granted. These CPDs may be broadcast to users in the form of a service guide, step 201. The content manager server 6 may receive user requests for the broadcast content program at the static price. So long as the content manager server 6 is operating in a static pricing mode, the content manager server 6 may continue to grant users viewing access in exchange for the static price only.

At some time prior to actual broadcast time of the sporting event, the mobile TV broadcast service provider may elect to initiate the dynamic pricing mode. Thus, the content manager server 6 may periodically determine whether the time remaining before to actual broadcast time exceeds some predetermined threshold, determination 202. If the time to broadcast exceeds the predetermined threshold (i.e., determination 202=No), then the content manager server 6 continues to insert the CPDs into the service guide with the static price. However, if the time to actual broadcast is below the predetermined threshold (i.e., determination 202=Yes), then the content manager server 6 may alter the CPDs to remove the static price for the broadcast content program from the service guide, step 203. The absence of the static price in the service guide may indicate that the mobile TV broadcast service provider is now operating in a dynamic price mode and is receptive to negotiable price offers from users.

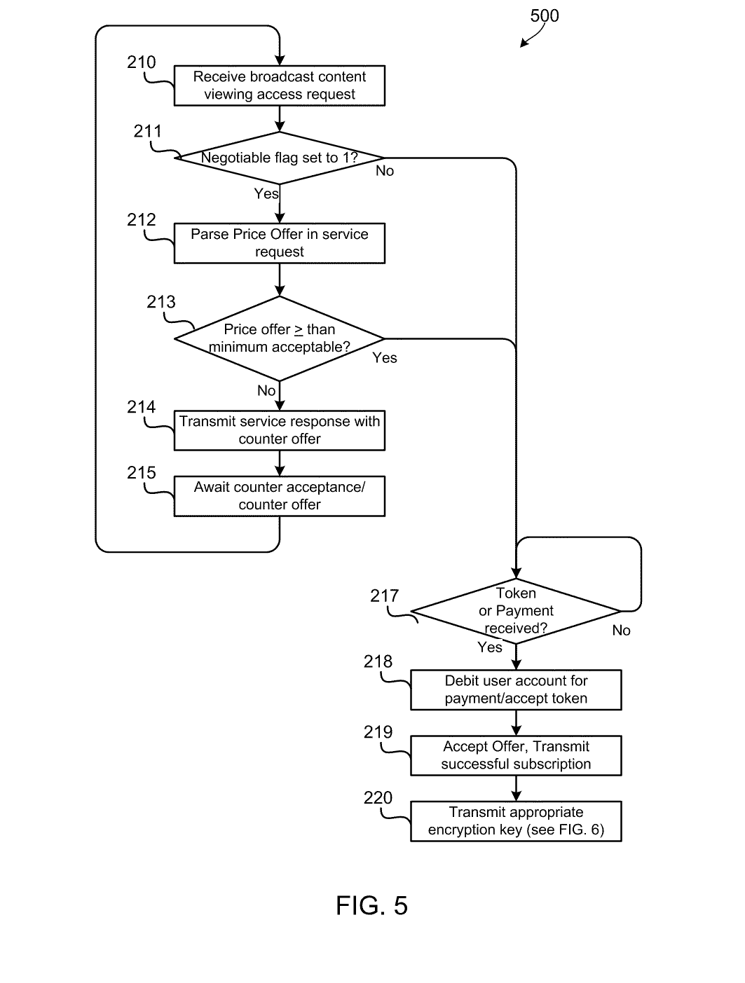

Alternatively, the content manager server 6 may insert explicit information in the service guide that the mobile TV broadcast service provider is operating in a dynamic pricing mode and is receptive to negotiable price offers from users. The content manager server 6 may set a negotiable flag to “1” to enable the dynamic pricing process, thereby making subsequent processing by the content manager server 6 (or price bidding manager 9) receptive to user negotiable price offers, step 204. The content manager server 6 may also set the minimum acceptable price for viewing access to the broadcast content program, step 205. Once the negotiable flag and the minimum acceptable price have been set, the content manager server 6 may perform the dynamic price negotiation process described in more detail below with reference to FIG. 5, step 206. The mobile TV broadcast service provider may elect to perform the dynamic price negotiation process until some predetermined time. This predetermined time may be prior to the start of the broadcast, but may extend until the end of the broadcast. For example, users may be allowed to negotiate prices for accessing the broadcast content up until the start of the scheduled broadcast content program.

Alternatively, the mobile TV broadcast service provider may allow users to obtain viewing access to a broadcast content program “already in progress.” In some embodiments, the mobile TV broadcast service provider may initiate another dynamic price negotiation process by resetting the minimum acceptable price for viewing access requests received after the broadcast content program has begun to be broadcast. If the time to negotiate the price has not expired (i.e., determination 207=No), then the content manager server 6 may continue to perform the broadcast content price negotiation process, step 206. However, if the time to negotiate has expired (i.e., determination 207=Yes), the content manager server 6 may reset the negotiable flag to “0”, step 208, and return to step 201 to insert broadcast content information in the service guide for other broadcast content programs.

FIG. 5 is a process flow diagram illustrating an embodiment method 500 for conducting a dynamic price negotiation. The content manager server 6 may receive broadcast content viewing access requests from users, step 210. In some instances, users may transmit requests for viewing access before the content manager server 6 is operating in the dynamic pricing mode. In such instances the user is requesting viewing access to the broadcast content program for the static price. Therefore, upon receipt of the user's viewing access request, the content manager server 6 may check to see if the negotiable flag has been set to “1” indicating that the content manager server 6 is operating in the dynamic pricing mode, determination 211. If the negotiable flag has not been set to “1” then the dynamic pricing operation period has not yet begun and the broadcast content viewing access is only available to users for the static price. Accordingly, if the negotiable flag is not set to “1” (i.e., determination 211=No), then the received broadcast content viewing access request may be treated as an agreement to be charged the static price. The content manager server 6 may await confirmation that either a token of payment has been received, determination 217. Users may prepay, receive and store tokens on their mobile devices 10 which may be redeemed for viewing access to broadcast programs. Some broadcast programs may require the submission of one or multiple tokens before viewing access is granted. In this manner, money is no longer exchanged for viewing access. If a token or payment has not been received (i.e., determination 217=No), then the content manager server 6 may continue to await confirmation of token/payment receipt, determination 217. Once a token or payment has been received (determination 217=Yes), the content manager server 6 (or separate billing server in communication with the content manager server 6) may debit the user account for payment or accept the token(s), step 218. The content manager server 6 may generate and transmit a message to the mobile device that the user has purchased access to the broadcast, step 219. The content manager server 6 may then initiate the process to transmit the appropriate decryption key, step 220. The process for transmitting the appropriate decryption key is described in more detail below with reference to FIG. 6.

If the negotiable flag is set to “1” (i.e., determination 211=Yes), then the content manager server 6 may parse the user's request to obtain the user's price offer (via the program bidding manager 9), step 212. The content manager server 6 may then determine if the offered price is greater than or equal to the minimum acceptable price set in step 205 of FIG. 4, determination 213. If the parsed price offered by the user is greater than or equal to the minimum acceptable price (i.e., determination 213=Yes), the content manager server 6 may accept the user's price offer, accept payment and transmit the appropriate decryption keys, steps 217-219. If the parsed price offer is less than the minimum acceptable price (i.e., determination 213=No), the content manager server 6 may generate and transmit a counter offer containing a proposed price for viewing access, step 214. As discussed above, any of a variety of negotiation algorithms may be implemented by the content manager server 6 to generate appropriate counter offers. Once the counteroffer has been generated and transmitted back to the user via the bi-directional link in the unicast network 5, the content manager server 6 may await the user's acceptance, rejection or counter to the counteroffer, step 215.

A variety of mechanisms may be used to link decryption keys to subscription purchases. Typically, mobile broadcast services utilize unicast communication networks, such as a customer's cellular telephone data service, to communicate subscription messages to/from particular customer mobile devices, and a separate broadcast network to broadcast the mobile television programming to all mobile devices. In overview, a mobile broadcast service provider can transmit messages which include information that enables a mobile device 10 to generate the decryption keys needed to receive a particular broadcast. Decryption keys may be configured to expire after a predetermined amount of time in order to enable pay-per-view (pay-per-play) type services, as well as limit the economic impact of decryption keys falling into the public domain. Additionally, the messages providing decryption keys may include service limitation parameters that may be used to limit received broadcast services to particular programs, channels, or other market segmentations.

The various embodiments may be implemented within the OMA BCAST technologies, for example, by transmitting to customers a temporary LTKM that will expire within a limited period of time when the user's account has been charged the negotiated program viewing price. When the LTKM is received, the mobile device may use that message content to decrypt portions of STKM messages to obtain a TEK to view the requested broadcast transmission.

FIG. 6 is a process/message flow diagram illustrating an embodiment method 600 for providing the user with the appropriate decryption keys once the negotiation between a user and the mobile TV broadcast service provider is successfully completed. As discussed above with reference to FIGS. 4 and 5, the user may engage in a negotiation process with the mobile TV broadcast service provider via the content manager server 6, steps 206 and 306. Once the negotiation has been successfully completed, the content manager server 6 may transmit a message to the user's mobile device 10 indicating the successful negotiation, step 219. In addition, the content manager server 6 may also transmit a message to the content provider server 8 informing it of the successful negotiation and the identity of the user's mobile device 10 with which the successful negotiation was conducted, step 219. The successful negotiation message may be received by the user's mobile device 10, step 319, as well as the content provider server 8, step 119. Upon receipt of the successful negotiation message the content provider server 8 may initiate the process to provide the user with the appropriate decryption keys to be able to view the purchase broadcast program.

In response to the received successful negotiation message (step 119), the broadcast content provider 8 may create and send a long term decryption key message, such as a LTKM, for the use by the user's mobile device 10 to the content manager server 6, step 123. This LTKM may include the terms and conditions under which the mobile device 10 can decrypt TEKs within STKMs in order to decrypt and display the content of the purchased program. The LTKM transmitted to the content manager server 6 may also include restricted access keys to allow the user to only view the broadcast program under certain restricted terms. The LTKM is transmitted using the unicast network 5.

At the same time, the broadcast content provider 8 is also broadcasting a continuous sequence of STKMs as well as the encrypted broadcast content, step 125. The content manager server 6 may receive and send the LTKM, steps 223, 224. The mobile device 10 receives the LTKM via the unicast network 5, step 324. The mobile device 10 also receives the STKM streams and encrypted content streams via the broadcast network 3, step 325. The mobile device 10 may use the LTKM to decrypt the TEK included in the STKM stream. The TEK is then used to decrypt the purchased broadcasted content. With the broadcasted content decrypted, the mobile device may display the content to the user for viewing, step 326.

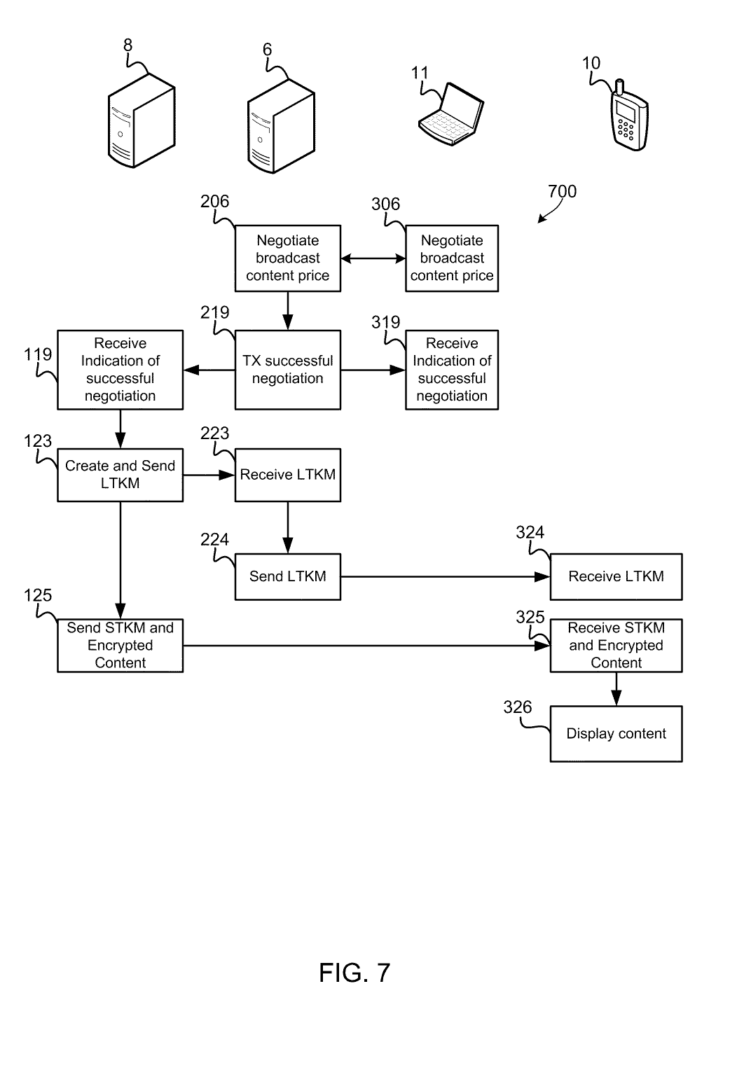

FIG. 7 shows process/message flow 700 of an alternative embodiment method for providing the user with the appropriate decryption keys when the negotiation between a user and the mobile TV broadcast service provider is conducted at a secondary user terminal. As discussed above, in some embodiments a user may wish to pre-order a program for broadcast receipt on a mobile device from a remote secondary user terminal 11. The process/message flow 700 shown in FIG. 7 is significantly similar to the method 600 illustrated in FIG. 6. In process/message flow 700, the broadcast content price is negotiated between a secondary user terminal 11 and the content manager server 6, steps 206, 306. Upon successful completion of the negotiation, the content manger server 6 may transmit an indication of the successful negotiation (step 219) which may be received by the content provider 8 (step 119) as well as the secondary user terminal 11 (step 319). As above, the broadcast content provider 8 may create and send a long term decryption key message, such as a LTKM, for the use by the user's mobile device 10 to the content manager server 6, step 123. The LTKM transmitted to the content manager server 6 may also include restricted access keys to allow the user to only view the broadcast program under certain restricted terms.

At the same time, the broadcast content provider 8 is also broadcasting a continuous sequence of STKMs as well as the encrypted broadcast content, step 125. The content manager server 6 may receive and send the LTKM, steps 223, 224. The mobile device 10 receives the LTKM via the unicast network 5, step 324. The mobile device 10 also receives the STKM streams and encrypted content streams via the broadcast network 3, step 325. The mobile device 10 may use the LTKM to decrypt the TEK included in the STKM stream. The TEK is then used to decrypt the purchased broadcasted content. With the broadcasted content decrypted, the mobile device may display the content to the user for viewing, step 326.

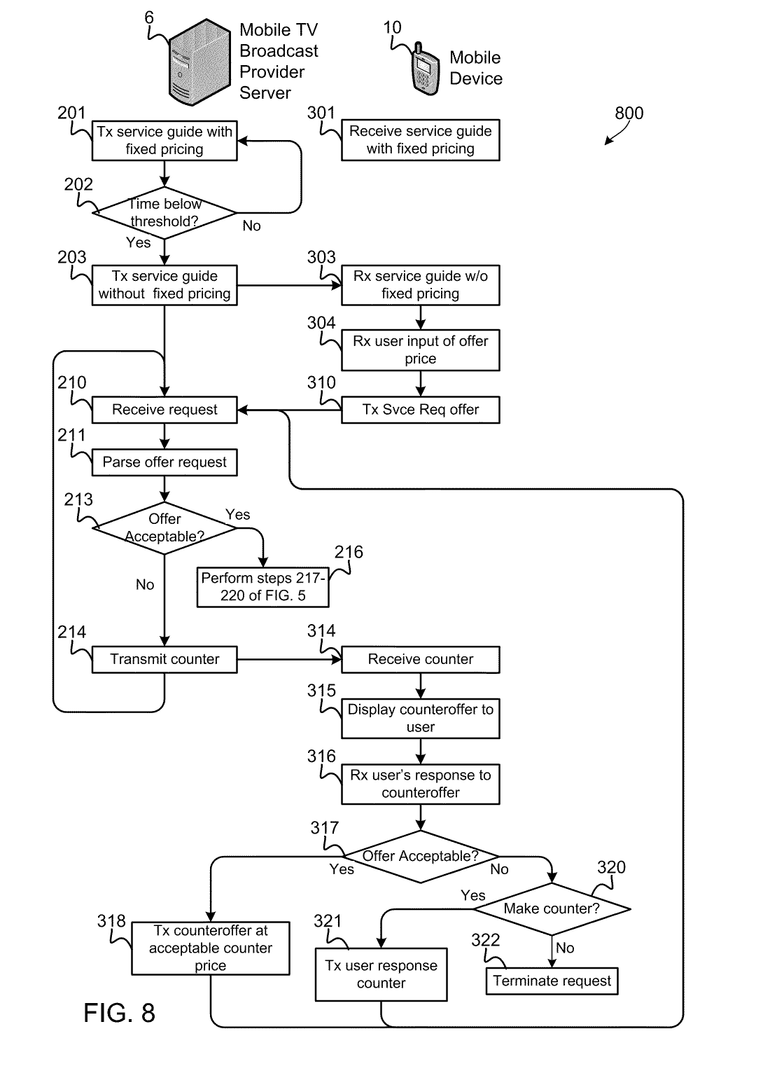

FIG. 8 is a process flow diagram illustrating an embodiment method 800 performed by various elements within the broadcast system in an embodiment negotiation. The content manager server 6 may transmit a service guide containing information regarding various broadcast content programs, step 201. Included with this information may be a fixed price for obtaining viewing access to the broadcast content. Through the mobile TV broadcast transmissions 3, users may receive the service guide with fixed prices on their mobile device 10, step 301. Users may elect to request viewing access to the broadcast content program described in the service guide at the fixed price (not shown).

As the content manager server 6 transmits the service guide, it may periodically monitor the time remaining before the broadcast time for the broadcast content program. If the time remaining before broadcast is less than a predetermined threshold (i.e., determination 202=No), the content manager server 6 may continue to transmit the service guide containing a fixed price for the broadcast content program, step 201. Once the time remaining before broadcast is less than the predetermined threshold (i.e., determination 203=Yes), the content manager server 6 may transmit a service guide update with no pricing information regarding the particular broadcast content program, step 203. For example, the content manager server 6 may update the “PurchaseData” fragment in the OMA-BCAST in the transmission (assuming no other portions of the service guide have changed).

By transmitting the service guide without any pricing information, the content manager server 6 indicates to mobile devices 10 that the price to view the broadcast program is negotiable. In an alternative embodiment, the content manager server 6 may transmit a service guide update with an explicit message indicating that the price to view the broadcast program is negotiable. Users may receive the service guide without pricing information (or with explicit information regarding a negotiable price) on their mobile devices 10, step 303. In response to receiving information that the price is negotiable, the mobile device 10 may prompt the user to enter an offer price and receive the user's input of a negotiable offer price, step 304. Once the user's request and price offer is received, the mobile device 10 may transmit the information to the content manager server 6 via the unicast network, step 310.

The content manager server 6 receives the user's request, step 210 and performs steps 211-220 as discussed above with reference to FIG. 5. When the content manager server 6 replies with a counteroffer, step 214, the user's mobile device 10 may receive the counteroffer, step 314, and displays the counter offer to the user, step 315. The user may then respond to the counter offer by accepting the counter offer, proposing a counter to the counter offer, or rejecting the offer. The mobile device 10 may receive the user inputted response, step 316, and determine whether user accepted the offer, determination 317. If the user indicates that the counter offer is acceptable (i.e., determination 317=Yes), the mobile device 10 may transmit the counter offer as a new offered price to the content manager server 6, step 318. Since the new offered price is already a price that is acceptable to the content manager server 6, the user's counter offer will be acceptable to the content manager server 6. Consequently, when the counter offer is received, step 210 and parsed, step 211, the content manager server 6 will accept the counter and subsequently transmit the appropriate decryption keys to allow viewing access, steps 217-220 in FIG. 5. Alternatively, the mobile device 10 may transmit a message to the content manager server 6 accepting the counter offer, in which case the content manager server 6 may proceed with a transaction in a manner similar to when the user accepts a static price as described above with reference to FIG. 5 (e.g., determination 211=No; steps 217-220).

Alternatively, the user may elect to counter the counter offer. If the mobile device 10 determines from the user input that the content manager server's 6 counter is not acceptable (i.e., determination 317=No), the mobile device 10 may prompt the user to indicate whether the user wishes to make a counter to the counter offer or reject the counter offer. The mobile device 10 may receive the user input and determine whether the user wishes to accept or reject the counter offer, determination 230. If the mobile device 10 determines that the user rejects the counter offer (i.e., determination 230=No), the mobile device 10 may terminate the broadcast request by transmitting a message to that effect to the content manager server 6 via the unicast network, step 322. If the mobile device 10 determines that the user wishes to counter the counter offer (i.e., determination 320=Yes), then the mobile device may prompt the user to input a counter offer price to the counter offer received from the content manager server 6. The mobile device 10 receives the counter price from the user and transmits the information to the content manager server 6 in a manner similar to the original request with a new offered price, step 321. Upon receipt of the counter to the counter offer, step 210, the content manager server 6 may evaluate the counter to the counter offer and accept or counter the most recently received offered in a manner similar to that described above with reference steps 210-220 in FIG. 5. This process may continue until a mutual agreement is reached or the user elects to terminate the negotiation. In some embodiments the process may be allowed to undergo a limited number of iteration in order to minimize the consumption of network resources (e.g., unicast network bandwidth.)

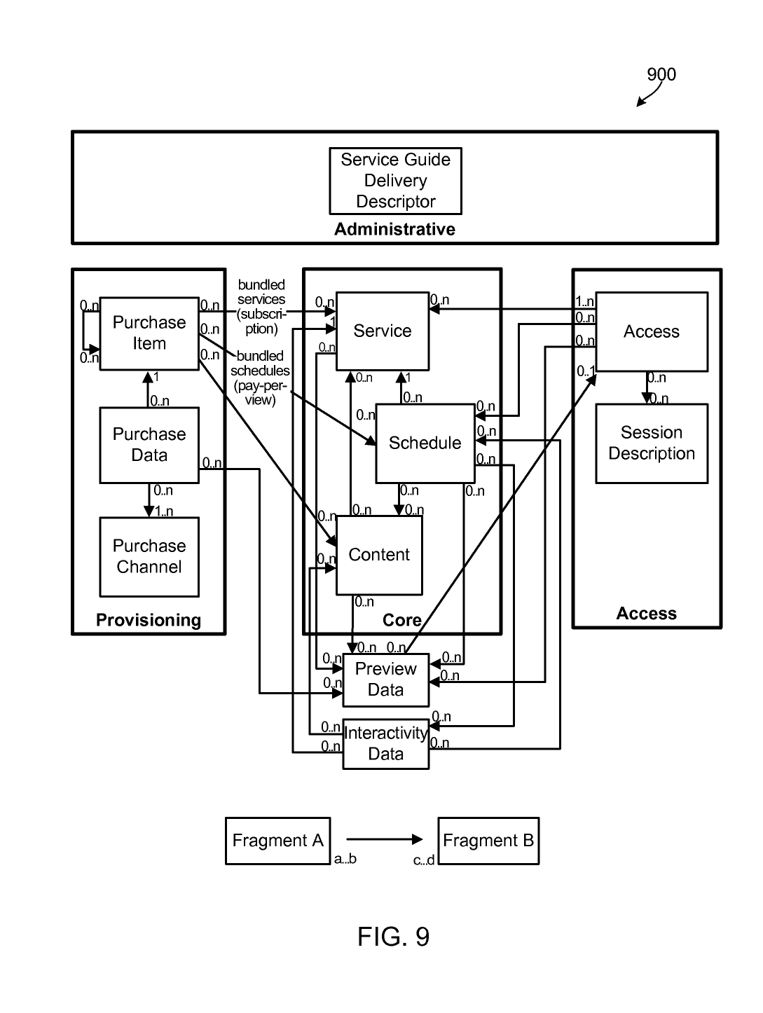

FIG. 9 shows service guide data model 900 in which the data is represented as XML fragments. Each XML fragment is considered to be a separate well-formed XML document. The XML text declaration may be omitted. In such a case, the mobile device 10 may assume the following default XML text declaration to ensure well-formedness:

<?xml version=“1/1”?>

The namespaces used in a fragment should be declared in the fragment according to XML rules. If no namespace is declared, the mobile device may assume that the default namespace of the fragment is “urn:oma:xml:bcast:sg:fragments:1.0”.

The cardinalities shown in service guide data model 900 of FIG. 9 have the following meanings. One instantiation of Fragment A references c to d instantiations of Fragment B. If c=d, d is omitted. Thus, if c>0 and Fragment A exists, at least c instantiation of Fragment B must also exist, but at most d instantiations of Fragment B may exist. Vice versa, one instantiation of Fragment B is referenced by a to b instantiations of Fragment A. If a=b, b is omitted. The arrow connection from Fragment A pointing to Fragment B indicates that Fragment A contains the references to Fragment B.

Any given ‘PurchaseItem’ fragment may only be able to reference a single type among the following fragments: ‘Service’, ‘Schedule’, ‘Content’, or another ‘PurchaseItem’. An ‘Access’ fragment may have a link to either a ‘Service’ fragment or a ‘Schedule’ fragment.

As shown in FIG. 9, all of the connection arrows between Service Guide fragments are uni-directional, except there are two pairs of opposite uni-directional arrows: between the ‘Schedule’ fragment and the ‘InteractivityData’ fragment; and between the ‘Access’ fragment and the ‘PreviewData’ fragment. The reference arrow from the ‘Schedule’ fragment to the ‘InteractivityData’ fragment declares the distribution schedule of the interactive media documents carried in a file stream (referenced by the ‘InteractivityData’ fragment). The reference arrow from the ‘InteractivityData’ fragment to the ‘Schedule’ fragment declares the ‘Schedule’ fragment with which the ‘InteractivityData’ fragment is associated. The reference arrow from the ‘Access’ fragment to the ‘PreviewData’ fragment indicates the service-by-service switching preview information for the access. The reference arrow from the ‘PreviewData’ fragment to the ‘Access’ fragment declares how the preview data can be accessed.

The semantics of the elements in the model as defined as follows; The ‘Service’ fragment describes at an aggregate level of the content items which comprise a broadcast service. The service may be delivered to the user using multiple means of access, for example, the broadcast channel and the interactive channel. The service may be targeted at a certain user group or geographical area. Depending on the type of the service it may have interactive part(s), broadcast-only part(s) or both.

The service may further include components not directly related to the content but to the user acquisition related functionality of the service—such as purchasing or subscription information. As part of the Service Guide, the ‘Service’ fragment forms a central hub referenced by the other fragments including ‘Access’, ‘Schedule’, ‘Content’ and ‘PurchaseItem’ fragments. In addition, the ‘Service’ fragment may reference the ‘PreviewData’ fragment. The ‘PreviewData’ fragment may be referenced by none or several of each of these fragments.

Together with the associated fragments the mobile device 10 may determine the details associated with the service at any point of time. These details may be summarized into a user-friendly display, for example, of what, how and when the associated content may be consumed and at what cost.

The ‘Schedule’ fragment defines the timeframes in which associated content items are available for streaming, downloading and/or rendering. This fragment references the ‘Service’ fragment. If it also references one or more ‘Content’ fragments or ‘InteractivityData’ fragments, then it defines the valid distribution and/or presentation time frame of those content items belonging to the service, or the valid distribution timeframe and the automatic activation time of the InteractivityMediaDocuments associated with the service. On the other hand, if the ‘Schedule’ fragment does not reference any ‘Content’ fragment(s) or ‘InteractivityData fragment(s), then it defines the timeframe of the service availability which is unbounded.

The ‘Content’ fragment gives a detailed description of a specific content item. In addition to defining a type, description and language of the content, it may provide information about the targeted user group or geographical area, as well as genre and parental rating.

The ‘Content’ fragment may be referenced by Schedule, PurchaseItem or ‘InteractivityData’ fragment. It may reference the ‘PreviewData’ fragment or the ‘Service’ fragment.

The ‘Access’ fragment describes how the service may be accessed during the lifespan of the service. This fragment contains or references Session Description information and indicates the delivery method. One or more ‘Access’ fragments may reference a ‘Service’ fragment, offering alternative ways for accessing or interacting with the associated service.

For the Mobile device 10, the ‘Access’ fragment provides information on the capabilities that are required from the mobile device 10 to receive and render the service. The ‘Access’ fragment provides Session Description parameters either in the form of inline text, or through a pointer in the form of a URI to a separate Session Description. The Session Description information may be delivered over either the broadcast channel or the interaction channel.

The ‘SessionDescription’ is a Service Guide fragment which provides the session information for access to a service or content item. Further, the Session Description may provide auxiliary description information, used for associated delivery procedures.

The Session Description information may be provided using either syntax of SDP in text format, or through a 3GPP MBMS User Service Bundle Description [3 GPP TS 26.346] (USBD).

Auxiliary description information may be provided in XML format and contains an Associated Delivery Description as specified in [BCAST10-Distribution].

Note that in case SDP syntax is used, an alternative way to deliver the Session Description is by encapsulating the SDP in text format in the ‘Access’ fragment.

The Session Description as a concept may be used both for Service Guide delivery itself as well as for the content sessions.

The ‘PurchaseItem’ fragment represents a group of one or more services (i.e. a service bundle) or one or more content items, offered to the end user for free, for subscription and/or purchase.

This fragment can be referenced by ‘PurchaseData’ fragment(s) offering more information on different service bundles. The ‘PurchaseItem’ fragment may be also associated with:
a ‘Service’ fragment to enable bundled services subscription and/or,
a ‘Schedule’ fragment to enable consuming a certain service or content in a certain timeframe (pay-per-view functionality) and/or,
a ‘Content’ fragment to enable purchasing a single content file related to a service, and
other ‘PurchaseItem’ fragments to enable bundling of purchase items PurchaseData.

The main function of the ‘PurchaseData’ fragment is to express all of the available pricing information about the associated purchase item.

The ‘PurchaseData’ fragment collects the information about one or several purchase channels and may be associated with PreviewData specific to a certain service or service bundle. It carries information about pricing of a service, a service bundle, or, a content item. Also, information about promotional activities may be included in this fragment.

The ‘PurchaseChannel’ fragment carries the information about the entity, i.e. a content provider or content aggregator, from which purchase of access and/or content rights for a certain service, service bundle or content item may be obtained, as defined in the ‘PurchaseData’ fragment. The purchase channel is associated with one or more mobile TV service providers. The mobile device is only permitted to access a particular purchase channel if it is affiliated with a mobile TV service provider that is also associated with that purchase channel.

Multiple purchase channels may be associated to one ‘PurchaseData’ fragment. In other words, the same price terms for subscription to a program may be simultaneously offered by different Mobile TV service providers. A certain end-user can have a “preferred” purchase channel (e.g. his/her mobile operator) to which all purchase requests should be directed. The preferred purchase channel may even be the only channel that an end-user is allowed to use.

The ‘PreviewData’ fragment contains information that is used by the mobile device to present the service or content outline to users, so that the users can have a general idea of what the service or content is about. The ‘PreviewData’ fragment can include simple texts, static images (for example, logo), short video clips, or even reference to another service which could be a low bit rate version for the main service. The ‘Service’, ‘Content’, ‘PurchaseData’, ‘Access’ and ‘Schedule’ fragments may reference the ‘PreviewData’ fragment.

The InteractivityData contains information that is used by the mobile device to offer interactive services to the user, which is associated with the broadcast content. These interactive services may enable users to vote during TV shows or to obtain content related to the broadcast content. The ‘InteractivityData’ fragment points to one or many ‘InteractivityMedia’ documents that include HTML files, static images, email template, SMS template, MMS template documents, etc. The ‘InteractivityData’ fragment may reference the ‘Service’, ‘Content’ and ‘Schedule’ fragments, and my be referenced by the ‘Schedule’ fragment.

The ServiceGuideDeliveryDescriptor (SGDD) is transported on the Service Guide Announcement Channel, and informs the mobile device of the availability, metadata and grouping of the fragments of the Service Guide in the Service Guide discovery process (see section 6.1.1.). A SGDD allows quick identification of the Service Guide fragments that are either cached in the mobile device or being transmitted. For that reason, the SGDD is preferably repeated if distributed over the broadcast channel. The SGDD also provides the grouping of the related Service Guide fragments, and thus a means to determine completeness of such a group.

The ServiceGuideDeliveryDescriptor is especially useful if the mobile device moves from one service coverage area to another. In this case, the ServiceGuideDeliveryDescriptor can be used to quickly check which of the Service Guide fragments that have been received in the previous service coverage area are still valid in the current service coverage area, and therefore don't have to be re-parsed and re-processed.

A service request is sent by the mobile device 10 to the content manager server 6 to request the subscription to, or purchase of, the associated purchase item. If the price is specified in the request message and it differs from the price calculated by the content manager server 6 for one or more of the purchase items included in the request, the content manager server 6 may respond with a Pricing Information Response message. Also, if the price is not specified for one or more of the purchase items in the request message, the content manager server 6 may respond with a Pricing Information Response message. Otherwise, the content manager server 6 may respond with a Service Response message.

The Pricing Information Response message contains the PurchaseItem and PurchaseDataFragment elements. The PurchaseItem element describes the price information of a PurchaseItem and includes a PurchaseDataReference element. In turn the PurchaseItem includes a Price element having validTo and currency attributes along with the element Negotiable. When ‘Price’ is absent in this Pricing Information Response message, this element indicates that the purchase price is negotiable in a subsequent purchase transaction.

If ‘negotiable’=true or 1, this indicates the monetary price of the referenced purchase item is negotiable (i.e. the user can submit a price offer in a subsequent Service Request or Token Purchase Request message).

If ‘negotiable’=false or 0, this indicates the monetary price of the referenced purchase item is not negotiable with the user (i.e. the user can accept a static price offer in a subsequent Service Request or Token Purchase Request message).

Purchase Data fragments are specified in [BCAST10-SG] which contains price related information for the requested Purchase Item(s). Either the ‘PurchaseDataReference’ fragment or the ‘PurchaseDataFragment’ fragment, but not both, may be instantiated in the ‘Pricing Information Response’ message.

A Service Request Message may contain the following elements: UserID; DeviceID; ServiceEncryptionProtocol; PurchaseItem; and either DrmProfileSpecificPart or SmartcardProfileSpecificPart. In the case of the Smartcard Profile, the ‘SmartcardProfileSpecificPart’ may be omitted if the message is used for the purpose of subscription or purchase, and may be included if the message is used to request delivery of SEK(s)/PEK(s).

The PurchaseItem element contains the list and price of items the user wants to order and the list of services to which the user wants to subscribe. The PurchaseItem includes the PurchaseDataReference, Price, PriceOffer, and Service elements. The PriceOffer element represents the price offer by the user for the purchase of the referenced PurchaseItem. Its (optional) presence may be triggered by either of two events: a) the price of the Purchase Item is signaled in the ‘PurchaseDataFragment’ element of the ‘Pricing Information Response’, and the ‘negotiable’ attribute=true or 1, or b) the user/mobile device has determined that the purchase price is negotiable from the Service Guide (i.e. the ‘MonetaryPrice’ element in the PurchaseData fragment is absent).

A Service Response Message may be sent to the mobile device from the content manager server 6 in response to the request for subscription to the Service Request message. This message is applicable to both the DRM Profile and Smartcard Profile. The Service Response Message includes a PurchaseItem element that describes the results of the request message of subscribing to or purchasing the PurchaseItem. For the DRM Profile, if subscription or purchase is successful, rightsValidityEndTime of PurchaseItem will be present. For either the DRM Profile or Smartcard Profile, in the case of subscription/purchase failure, item WiseStatusCode will be present to indicate the reason why the request is not accepted by the content manager server 6. The PurchaseItem element includes an Acceptability element that should the Service Request contain the element ‘PriceOffer’, indicates whether that price offer is accepted by the content manager server 6. ‘Acceptability’=true or 1 indicates that the offered price from the user for the purchase of this purchase item, as contained in the ‘Service Request’ message, is accepted by the content manager server 6. ‘Acceptability’=false or 0 indicates that the offered price from the user for the purchase of this purchase item, as contained in the ‘Service Request’ message, is not accepted by the content manager server 6. The Acceptability element contains a CounterPrice element that if ‘Acceptability’=false or 0, presence of this element indicates the counter-offer price from the content manager server 6 for this purchase item is accepted.

Token Purchase Request Messages and Token Purchase Response Messages may be similarly configured as the Service Request Message and the Service Response Messages.

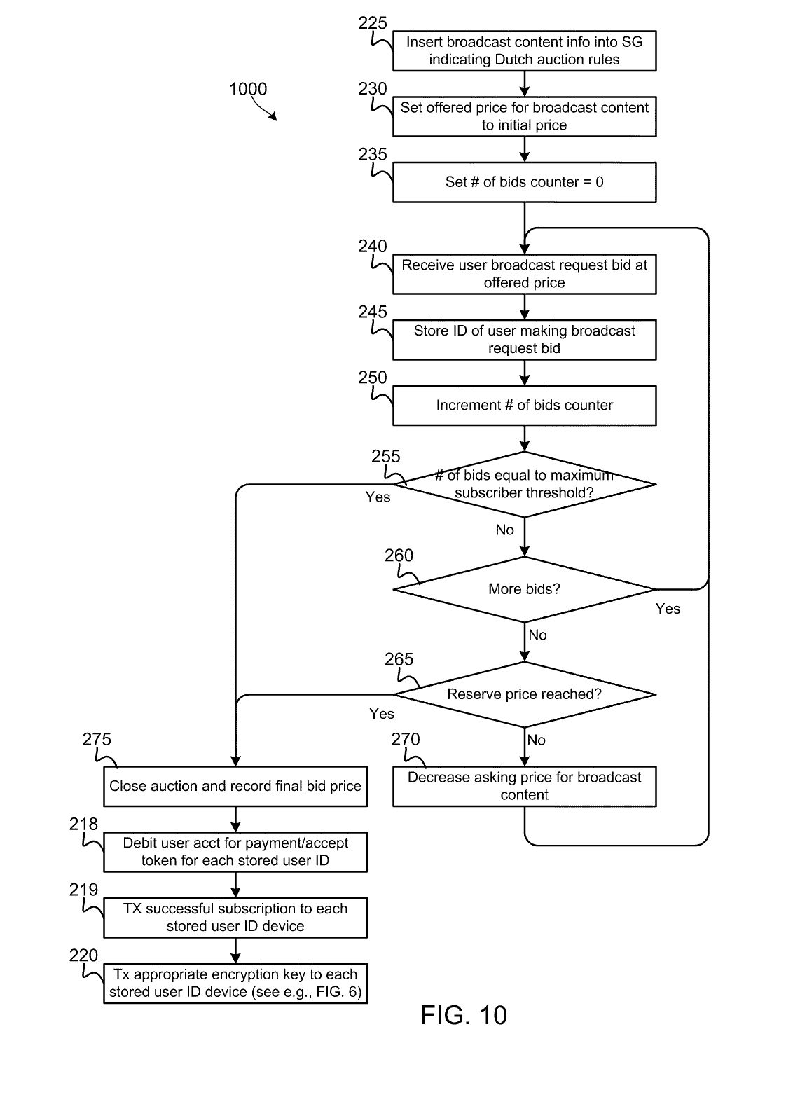

FIG. 10 is a process flow diagram illustrating an alternative dynamic pricing method 1000 that may be implemented by a content manager server 6. Rather than accepting conventional static pricing or conducting a negotiation process for pricing of viewing access, various auctions may be implemented to arrive at an acceptable price for viewing a broadcast program. In the auction method 1000 shown in FIG. 10, the seller (e.g., the mobile TV broadcast service provider) announces a high initial asking price for viewing to the broadcast program. The asking price is lowered at predetermined intervals of time. As the price is lowered, users may transmit a purchase request to the content manager server 6 indicating that they are willing to purchase the broadcast content program at the current asking price. The asking price may continue to be lowered until either the maximum number of subscriptions offered through the auction is reached or a predetermined reserve price is reached. Once either end point is reached all users who transmitted a purchase request may be billed the final asking price and receive viewing privileges in return. Only users who submit a purchase request are granted viewing access. Therefore, potential users who delay submitting a bid in the hopes of a lower price may be precluded from viewing the program if the maximum number of subscriptions is obtained before the potential users' desired price is announced. Thus, users interested in a broadcast program are motivated to accept a higher asking price to ensure they are able to purchase viewing privileges. Similarly, users who submit a bid early run the risk of the fulfilling the maximum number of subscriptions early. As a result, those users may pay more for the broadcast content program than originally intended.

Other auction variations may be implemented. For example, rather than having all of the bidders pay the final price, each bidder may be required to pay their purchase request price. For example, the mobile TV broadcast service provider may inform all potential bidders that only a limited number of subscriptions will be available through the auction. In order to insure that they are not precluded from obtaining viewing access, bidders may elect to submit a bid early at a higher price. Those bidders who wish to ensure viewing access may be required to pay their early higher price as opposed to bidders who bid late and risk being precluded from obtaining viewing access.

In another embodiment, the mobile TV broadcast service provider may limit the number of subscriptions available at given prices. Once all of the limited number of subscriptions are fulfilled at a given price the asking price may be lowered. By decreasing the number of subscriptions available at a particular price as the asking price is lowered, potential bidders are encouraged to bid in order to insure they receive viewing access.

In another embodiment, the mobile TV broadcast service provider may elect to lower the asking price at given intervals. However, since potential bidders do not know what the reserve price is, the potential bidders do not know when the auction may end. If a potential bidder delays submitting a purchase request in the hopes that the price will continue to be lowered, the auction may end before the bidder submits a purchase request.

FIG. 10 is a process flow diagram of an embodiment method 1000 that may be implemented by the content manager server 6 to provide a type of auction well suited to the broadcast environment. As previously discussed, the content manager server 6 generates and inserts CPDs regarding a broadcast content program into a service guide that is transmitted to mobile TV users over the broadcast network 3. The content manager server 6 may insert broadcast content information into the service guide indicating that a particular broadcast content program is available via the auction, step 225. The CPDs may provide users (potential bidders) with the particular rules governing the auction. For example, the content manager server 6 may inform users that they must submit a bid to obtain viewing access, that the auction may be ended when the number of accepted bids exceeds a particular threshold or the reserve price is met, that the asking price will be periodically lowered, and that the price that each user will be charged may be determined by the final asking bid that is accepted in the auction.

After the rules of the auction have been sufficiently broadcast to users, the content manager server 6 may set the initial asking price, step 230. The content manager may also set a bid counter to zero (0), step 235. At that point, the content manager server 6 may start the auction and begin to receive bids or purchase request from users, step 240. As each bid or purchase request is received, the content manager server 6 records and stores an identifier for the user's mobile device 10 making the broadcast content program request bid or purchase request, step 245. The content manager server 6 then increments the bid counter, step 250, and determines if the total number of bids is equal to the maximum number of subscriptions available through the auction process, determination 255. If the number of bids is equal to the maximum number of subscriptions available (i.e., determination 255=Yes), the content manager server 6 may close the auction and record the final asking price, step 275. Once the auction is closed, the content manager server 6 may directly or through a billing server (not shown) debit payment or accept a token in the amount of the final asking price for each user account associated with an identifier stored in step 245, step 218. The content manager server 6 may then transmit a message to each mobile device associated with the stored identifiers of the successful subscriptions, step 219. The content manager server 6 may then initiate the necessary steps to transmit the appropriate decryption keys to each mobile device associated with a stored identifier, such as through the process described above with reference to FIG. 6, step 220.

If the number of bids is not equal to the maximum number of subscriptions available (i.e., determination 255=No), the content manager server 6 may determine if more bids or purchase request are being received, determination 260. If more bids are being received (i.e., determination 260=Yes), then the content manager server 6 may return to step 240 to continue receiving bids or purchase request from other user mobile devices. If no more bids are being received (i.e., determination 260=No), the content manager server 6 may determine whether the reserve price has been reached, determination 265. If the reserve price has been reached (i.e., determination 265=Yes), the content manager server 6 may close the auction, step 275, and perform steps 218-220 as described above. However, if the reserve price has not been reached (i.e., determination 265=No), the content manager server 6 may lower the asking price, step 270, and return to step 240 to receive additional bids or purchase request from users.

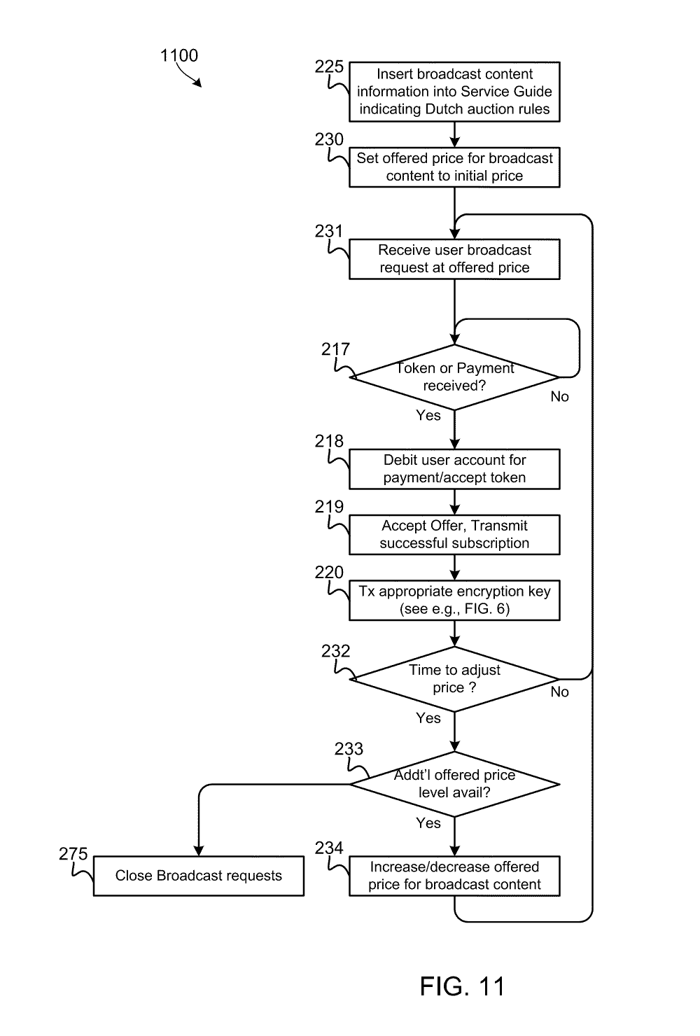

FIG. 11 is a process flow diagram illustrating an alternative embodiment auction method 1100 in which users are charged the asking price at the time the submit their purchase request as opposed to being charged the final asking price as in the embodiment illustrated in FIG. 10. The embodiment auction method 1100 shown in FIG. 11 also allows the content manager server 6 the option of increasing the asking price as well as decreasing the asking price. For example, in some instances as the program broadcast time approaches, the price a user is willing to pay for viewing access may increase. Alternatively, after a broadcast content program has started to be broadcast, the price a user is willing to pay for viewing access may decrease.

Similar to the method 1000 described above with reference to FIG. 10, the content manager server 6 may insert information regarding the particular auction rules into the service guide, step 225. Once the auction rules have been sufficiently broadcast to users so as to inform them of the auction and its rules, the content manager server 6 may set an initial asking price, step 230. Once the initial asking price is set, the auction may begin and the content manager server 6 may receive broadcast content request bids or purchase requests at the current asking price, step 231. When a broadcast content program request bid is received, the content manager server 6 (or a billing server) may perform steps 217-220 as described above with reference to FIG. 5 in order to properly accept payment and transmit appropriate decryption keys for viewing access, step 220. Periodically the content manager server 6 may determine if it is time to adjust the asking price, determination 232. If the time to adjust the asking price has not yet elapsed (i.e., determination 232=No), the content manager server 6 returns to step 231 and continues receiving broadcast content program request bids or purchase requests. When the time to adjust the price has elapsed (i.e., determination 232=Yes), the content manager server 6 determines if an additional offered asking price level is available, determination 233. In other words, the content manager server 6 determines if the reserve price has been met if the asking price is decreasing or if a maximum asking price has been met in an auction where the asking price is increasing. If no more additional offered asking price levels are available (i.e., determination 233=No), the content manager server 6 may close the auction and no longer accept broadcast program purchase requests, step 275. If additional offered asking price levels are available (i.e., determination 233=Yes), the content manager server 6 may increase (or decrease) the asking price for the broadcast program, step 234. Once the asking price has been adjusted, the content manager server 6 may return to step 231 to accept additional user bids or purchase requests at the adjusted asking price level. In this manner, each user who submits a bid or purchase request is charged the asking price at the time the user submitted their bid or purchase request.

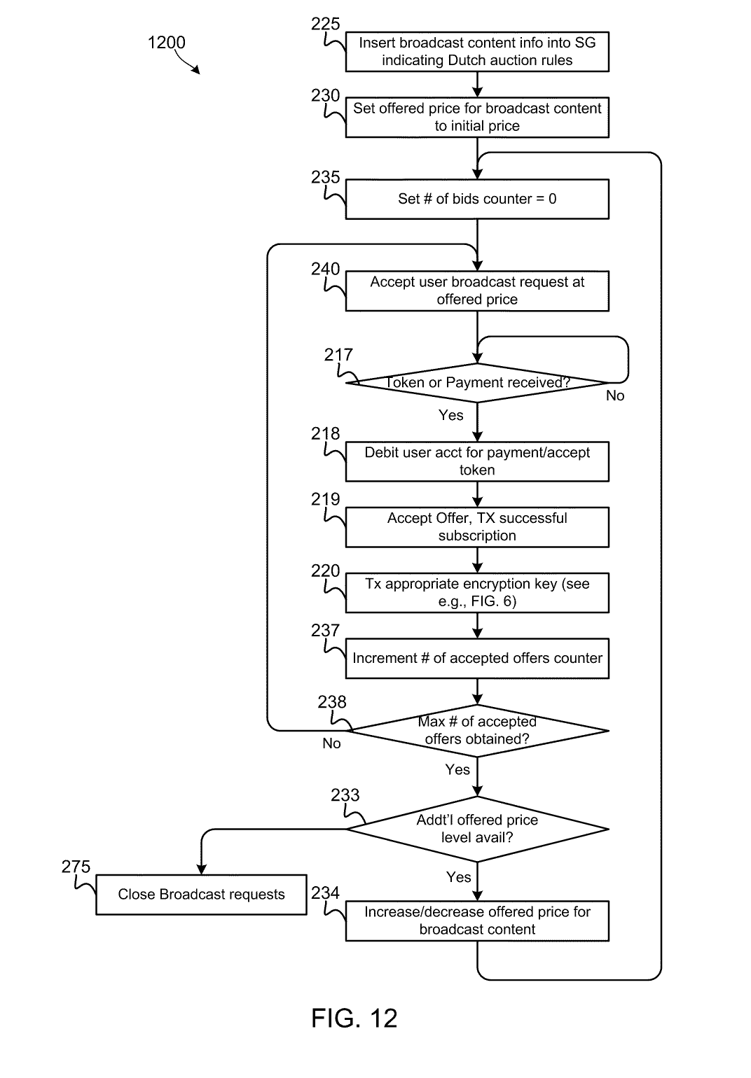

FIG. 12 is a process flow diagram of another alternative embodiment auction method 1200 in which a limited number of subscriptions are available at each price level in the auction. Similar to the auction method 1000 described above with reference to FIG. 10, in method 1200 the content manager server 6 informs users of the auction rules through the service guide, sets the initial asking price, sets a bid counter to zero (0), and begins to receive bids from users, steps 225-240. However, in contrast to the auction method 1000 described above with reference to FIG. 10, but similar to the auction method 1100 described above with reference to FIG. 11, the individual users are charged the asking price at the time of their purchase request. Accordingly, the content manager server 6 receives payment, informs the user of a successful purchase, and transmits the appropriate decryption keys for viewing access as in steps 217-220 described above. As each bid or purchase request is processed and the decryption key is transmitted (step 220), the bid counter is incremented, step 237. The content manager server 6 then determines if the maximum number of available subscriptions for the current asking price have been sold, determination 238. If the maximum number of subscriptions for the current asking price level has not yet been sold (i.e., determination 238=No), then the content manager server 6 will continue to receive bids or purchase requests at the current asking price by returning to step 240. However, if the maximum number of subscriptions for the current asking price has been sold (i.e., determination 238=Yes), the content manager server 6 determines if there is another asking price level at which to offer subscriptions, determination 233. If there are no more additional asking price levels available (i.e., determination 233=No), the content manager server 6 may close the auction and no longer accept broadcast program purchase requests, step 275. If additional offered asking price levels are available (i.e., determination 233=Yes), the content manager server 6 may increase (or decrease) the asking price for the broadcast content, step 234. Once the asking price has been adjusted, the content manager server 6 may return to step 235 to reset the counter which counts the number of subscriptions sold at a particular asking price.

While the foregoing embodiment descriptions referred to mobile devices communicating with the mobile broadcast service provider via a unicast network, other communication links may be used. For example, such messages could be delivered to a server pool within the mobile broadcast service provider network via an anycast network communication without departing from the scope of the claims and the invention.

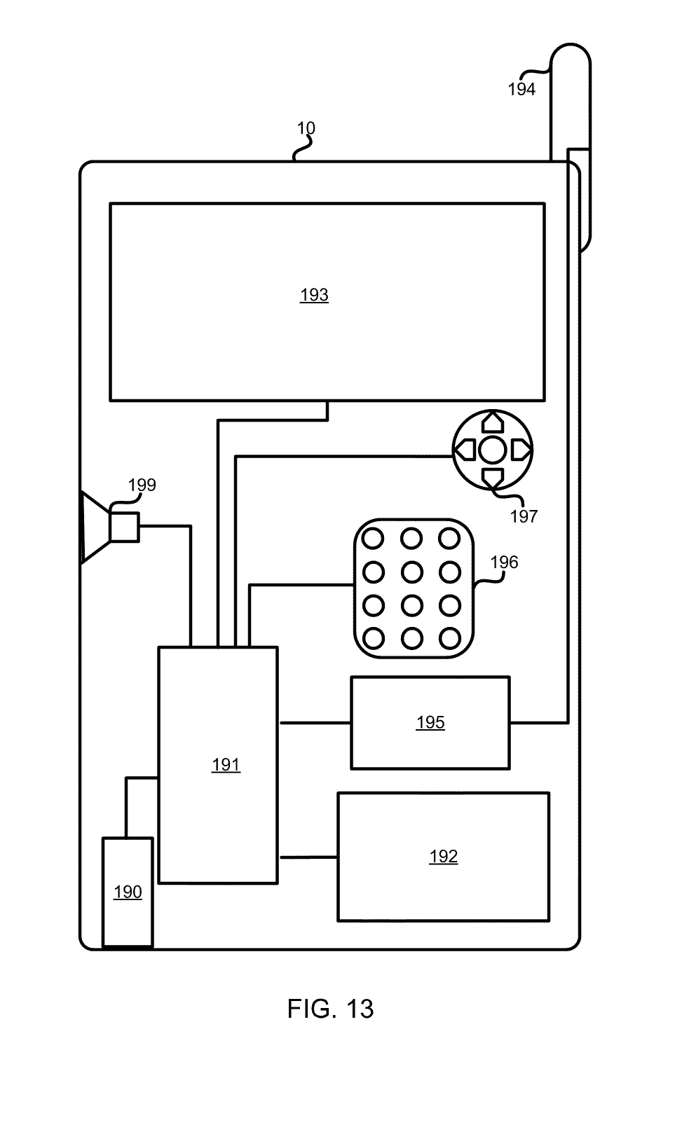

Typical mobile devices 10 suitable for use with the various embodiments will have in common the components illustrated in FIG. 13. For example, an exemplary mobile device 10 may include a processor 191 coupled to internal memory 192, a display 193, and to a speaker 199. Additionally, the mobile device 10 may have an antenna 194 for sending and receiving electromagnetic radiation that is connected to a wireless data link and/or cellular telephone transceiver 195 coupled to the processor 191. In some implementations, the transceiver 195 and portions of the processor 191 and memory 192 used for cellular telephone communications are collectively referred to as the air interface since it provides a data interface via a wireless data link. Mobile devices typically also include a key pad 196 or miniature keyboard and menu selection buttons or rocker switches 197 for receiving user inputs.

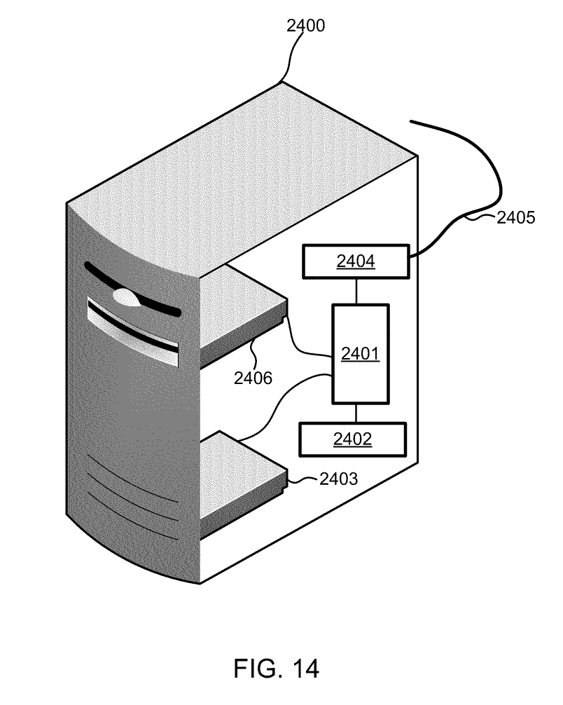

A number of the embodiments described above may also be implemented with any of a variety of general purpose computers or remote server devices, such as the server 2400 illustrated in FIG. 14. Such a server 2400 typically includes a processor 2401 coupled to volatile memory 2402 and a large capacity nonvolatile memory, such as a disk drive 2403. The server 210 may also include a floppy disc drive and/or a compact disc (CD) drive 2406 coupled to the processor 2401. The server 210 may also include network access ports 2404 coupled to the processor 2401 for communicating with network 2405, such as the Internet.

The processors 191, 2401 may be any programmable microprocessor, microcomputer or multiple processor chip or chips that can be configured by software instructions (applications) to perform a variety of functions, including the functions of the various embodiments described herein. In some mobile devices, multiple processors 191, 2401 may be provided, such as one processor dedicated to wireless communication functions and one processor dedicated to running other applications. Typically, software applications may be stored in the internal memory 192, 2402 before they are accessed and loaded into the processor 191, 2401. In some mobile devices and servers, the processor 191, 2401 may include internal memory sufficient to store the application software instructions. The mobile device 10 may also include a separate memory chip 190 such as smart card for storing information related to credits, token and coupons such as in an electronic purse according to the various embodiments. In some mobile devices, the secure memory may be in a separate memory chip coupled to the processor 191. In many mobile devices 10 and servers 2400, the internal memory 192, 2402 may be a volatile or nonvolatile memory, such as flash memory, or a mixture of both. For the purposes of this description, a general reference to memory refers to all memory accessible by the processor 191, 2401, including internal memory 192, 2402, a memory chip 190, removable memory plugged into the mobile device or server, and memory within the processor 191, 2401 itself.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module executed which may reside on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for dynamically pricing viewing access to a mobile TV broadcast program, comprising:
broadcasting a dynamic pricing message via a mobile TV broadcast network indicating that viewing access to a broadcast program is available through dynamic pricing;
receiving a dynamic price offer for viewing access to the broadcast program from a mobile device via a unicast network;
determining if the dynamic price offer is acceptable; and
transmitting decryption key information to the mobile device via the unicast network that will enable the mobile device to access the broadcast program if the dynamic price offer is determined to be acceptable.

2. The method of claim 1, further comprising:
transmitting a counter offer price to the mobile device if the dynamic price offer is determined to be not acceptable.

3. The method of claim 2, further comprising:
broadcasting a static pricing message via the broadcast network indicating that viewing access to a broadcast program is available through static pricing;
receiving a purchase request from the mobile device;
transmitting decryption key information to the mobile device via the unicast network that will enable the mobile device to access the broadcast program in response to receiving the purchase request; and
determining if a predetermined time threshold has been exceeded before broadcasting the dynamic pricing message.

4. The method of claim 3, wherein the dynamic price offer is determined to be acceptable if it is greater than a minimum acceptable price, and wherein the minimum acceptable price is less than the static price offer.

5. The method of claim 3, wherein the dynamic price offer is determined to be acceptable if it is greater than a minimum acceptable price, and wherein the minimum acceptable price is greater than the static price offer.

6. The method of claim 1, wherein the dynamic pricing is an auction process and wherein the dynamic price offer is a purchase request to access the broadcast program at a current asking price, the method further comprising:
storing an identifier of the mobile device from which the purchase request is received;
determining if additional subscriptions are available for purchase;
closing the auction process if no additional subscriptions are available for purchase;
determining if the current asking price equals a reserve price;
decreasing the asking price if the current asking price exceeds the reserve price;
closing the auction process if the current asking price equals the reserve price; and
charging a user account associated with the stored identifier the current asking price when the auction process was closed before transmitting of the decryption keys.

7. The method of claim 1, wherein the dynamic pricing is an auction process and wherein the dynamic price offer is a bid for viewing access to the broadcast content program at a current announced asking price, the method further comprising:
charging a user account the current asking price before said transmitting of the decryption keys;
determining if a time to adjust the current asking price has elapsed;
determining if the current asking price exceeds a reserve price;
adjusting the current asking price if the time to adjust the current asking price has elapsed and if the reserve price has not been met; and
closing the auction process if the current asking price does not exceed the reserve price.

8. The method of claim 7, wherein adjusting the current asking price comprises:
increasing the current asking price.

9. The method of claim 7, wherein adjusting the current asking price comprises:
decreasing the current asking price.

10. The method of claim 1, wherein the dynamic pricing is an auction process and wherein the dynamic price offer is a purchase request to access the broadcast program at a current asking price, the method further comprising:
charging a user account the current asking price before transmitting of the decryption keys;
determining if additional subscriptions for accessing the broadcast program are available at the current asking price;
determining if the current asking price exceeds a reserve price;
adjusting the current asking price if no additional subscriptions for viewing access to the broadcast content are available at the current asking price and the current asking price exceeds the reserve price; and
closing the auction process if the current asking price does not exceed the reserve price.

11. The method of claim 10, wherein adjusting the current asking price comprises:
increasing the current asking price.

12. The method of claim 10, wherein adjusting the current asking price comprises:
decreasing the current asking price.

13. A method for obtaining viewing access to dynamically priced mobile TV broadcast programs, comprising:
receiving a broadcasted dynamic pricing message via a mobile TV broadcast network indicating that viewing access to a broadcast program is available through dynamic pricing;
displaying the broadcasted dynamic pricing message;
receiving an inputted dynamic price offer for viewing access to the broadcast program;
transmitting the inputted dynamic price offer to a server within a mobile TV broadcast network via a unicast network; and
receiving decryption key information from the server within the mobile TV broadcast network via the unicast network that will enable access to the broadcast program.

14. The method of claim 13, further comprising:
receiving a counter offer price from the server within the mobile TV broadcast network;
displaying the received counter offer price;
receiving a user inputted response to the displayed counter offer price; and
transmitting a counter to the counter offer price to the server within the mobile TV broadcast network via the unicast network.

15. The method of claim 14, wherein the counter to the counter offer price is equal to the counter offer price if the received user inputted response indicates an acceptance of the counter offer price.

16. The method of claim 14, wherein the counter to the counter offer price is lower than the counter offer price if the received user inputted response indicates a rejection of the counter offer price.

17. A server within a mobile TV broadcast network method, comprising:
means for broadcasting a dynamic pricing message via a mobile TV broadcast network indicating that viewing access to a broadcast program is available through dynamic pricing;
means for receiving a dynamic price offer for viewing access to the broadcast program from a mobile device via a unicast network;
means for determining if the dynamic price offer is acceptable; and
means for transmitting decryption key information to the mobile device via the unicast network that will enable the mobile device to access the broadcast program if the dynamic price offer is determined to be acceptable.

18. The server of claim 17, further comprising:
means for transmitting a counter offer price to the mobile device if the dynamic price offer is determined to be not acceptable.

19. The server of claim 18, further comprising:
means for broadcasting a static pricing message via the broadcast network indicating that viewing access to a broadcast program is available through static pricing;
means for receiving a purchase request from the mobile device;
means for transmitting decryption key information to the mobile device via the unicast network that will enable the mobile device to access the broadcast program in response to receiving the purchase request; and
means for determining if a predetermined time threshold has been exceeded before broadcasting the dynamic pricing message.

20. The server of claim 19, wherein the dynamic pricing is an auction process and wherein the dynamic price offer is a purchase request to access the broadcast program at a current asking price, the server further comprising:
means for storing an identifier of the mobile device from which the purchase request is received;
means for determining if additional subscriptions are available for purchase;
means for closing the auction process if no additional subscriptions are available for purchase;
means for determining if the current asking price equals a reserve price;
means for decreasing the asking price if the current asking price exceeds the reserve price;
means for closing the auction process if the current asking price equals the reserve price; and
means for charging a user account associated with the stored identifier the current asking price when the auction process was closed before transmitting of the decryption keys.

21. The server of claim 17, wherein the dynamic pricing is an auction process and wherein the dynamic price offer is a bid for viewing access to the broadcast content program at a current announced asking price, the server further comprising:
means for charging a user account the current asking price;
means for determining if a time to adjust the current asking price has elapsed;
means for determining if the current asking price exceeds a reserve price;
means for adjusting the current asking price if the time to adjust the current asking price has elapsed and if the reserve price has not been met; and
means for closing the auction process if the current asking price does not exceed the reserve price.

22. The server of claim 21, wherein said means for adjusting the current asking price comprises:
means for increasing the current asking price.

23. The server of claim 21, wherein said means for adjusting the current asking price comprises:
means for decreasing the current asking price.

24. The server of claim 17, wherein the dynamic pricing is an auction process and wherein the dynamic price offer is a purchase request to access the broadcast program at a current asking price, the server further comprising:
means charging a user account the current asking price;
means for determining if additional subscriptions for accessing the broadcast program are available at the current asking price;
means for determining if the current asking price exceeds a reserve price;
means for adjusting the current asking price if no additional subscriptions for viewing access to the broadcast content are available at the current asking price and the current asking price exceeds the reserve price; and
means for closing the auction process if the current asking price does not exceed the reserve price.

25. The server of claim 24, wherein said means for adjusting the current asking price comprises:
means for increasing the current asking price.

26. The server of claim 24, wherein said means for adjusting the current asking price comprises:
means for decreasing the current asking price.

27. A mobile device capable of viewing mobile TV broadcast programs, comprising:
means for receiving a broadcasted dynamic pricing message via a mobile TV broadcast network indicating that viewing access to a broadcast program is available through dynamic pricing;
means for displaying the broadcasted dynamic pricing message;
means for receiving an inputted dynamic price offer for viewing access to the broadcast program;
means for transmitting the inputted dynamic price offer to a server within a mobile TV broadcast network via a unicast network; and
means for receiving decryption key information from the server within the mobile TV broadcast network via the unicast network that will enable access to the broadcast program.

28. The mobile device of claim 27, further comprising:
means for receiving a counter offer price from the server within the mobile TV broadcast network;
means for displaying the received counter offer price;
means for receiving a user inputted response to the displayed counter offer price; and
means for transmitting a counter to the counter offer price to the server within the mobile TV broadcast network via the unicast network.

29. The mobile device of claim 28, wherein the counter to the counter offer price is equal to the counter offer price if the received user inputted response indicates an acceptance of the counter offer price.

30. The mobile device of claim 28, wherein the counter to the counter offer price is lower than the counter offer price if the received user inputted response indicates a rejection of the counter offer price.

31. A server for dynamically pricing viewing access to a mobile TV broadcast program, comprising:
a server memory unit; and
a server processor coupled to the server memory unit, wherein the server processor is configured with software instructions to perform steps comprising:
broadcasting a dynamic pricing message via a mobile TV broadcast network indicating that viewing access to a broadcast program is available through dynamic pricing;
receiving a dynamic price offer for viewing access to the broadcast program from a mobile device via a unicast network;
determining if the dynamic price offer is acceptable; and
transmitting decryption key information to the mobile device via the unicast network that will enable the mobile device to access the broadcast program if the dynamic price offer is determined to be acceptable.

32. The server of claim 31, wherein the server processor is configured with software instructions to perform further steps comprising:
transmitting a counter offer price to the mobile device if the dynamic price offer is determined to be not acceptable.

33. The server of claim 32, wherein the server processor is configured with software instructions to perform further steps comprising:
broadcasting a static pricing message via the broadcast network indicating that viewing access to a broadcast program is available through static pricing;
receiving a purchase request from the mobile device;
transmitting decryption key information to the mobile device via the unicast network that will enable the mobile device to access the broadcast program in response to receiving the purchase request; and
determining if a predetermined time threshold has been exceeded before broadcasting the dynamic pricing message.

34. The server of claim 33, wherein the dynamic price offer is determined to be acceptable if it is greater than a minimum acceptable price, and wherein the minimum acceptable price is less than the static price offer.

35. The server of claim 33, wherein the dynamic price offer is determined to be acceptable if it is greater than a minimum acceptable price, and wherein the minimum acceptable price is greater than the static price offer.

36. The server of claim 31, wherein the dynamic pricing is an auction process and wherein the dynamic price offer is a purchase request to access the broadcast program at a current asking price, and wherein the server processor is configured with software instructions to perform further steps comprising:
storing an identifier of the mobile device from which the purchase request is received;
determining if additional subscriptions are available for purchase;
closing the auction process if no additional subscriptions are available for purchase;
determining if the current asking price equals a reserve price;
decreasing the asking price if the current asking price exceeds the reserve price;
closing the auction process if the current asking price equals the reserve price; and
charging a user account associated with the stored identifier the current asking price when the auction process was closed before transmitting of the decryption keys.

37. The server of claim 31, wherein the dynamic pricing is an auction process and wherein the dynamic price offer is a bid for viewing access to the broadcast content program at a current announced asking price, and wherein the server processor is configured with software instructions to perform further steps comprising:
charging a user account the current asking price before said transmitting of the decryption keys;
determining if a time to adjust the current asking price has elapsed;
determining if the current asking price exceeds a reserve price;
adjusting the current asking price if the time to adjust the current asking price has elapsed and if the reserve price has not been met; and
closing the auction process if the current asking price does not exceed the reserve price.

38. The server of claim 37, wherein the server processor is configured with software instructions to perform further steps comprising:
adjusting the current asking price by increasing the current asking price.

39. The server of claim 37, wherein the server processor is configured with software instructions to perform further steps comprising:
adjusting the current asking price by decreasing the current asking price.

40. The server of claim 31, wherein the dynamic pricing is an auction process and wherein the dynamic price offer is a purchase request to access the broadcast program at a current asking price, and wherein the server processor is configured with software instructions to perform further steps comprising:
charging a user account the current asking price before transmitting of the decryption keys;
determining if additional subscriptions for accessing the broadcast program are available at the current asking price;
determining if the current asking price exceeds a reserve price;
adjusting the current asking price if no additional subscriptions for viewing access to the broadcast content are available at the current asking price and the current asking price exceeds the reserve price; and
closing the auction process if the current asking price does not exceed the reserve price.

41. The server of claim 40, wherein the server processor is configured with software instructions to perform further steps comprising:
adjusting the current asking price by increasing the current asking price.

42. The server of claim 40, wherein the server processor is configured with software instructions to perform further steps comprising:
adjusting the current asking price by decreasing the current asking price.

43. A mobile device for obtaining viewing access to dynamically priced mobile TV broadcast programs, comprising:
a mobile device memory unit; and
a mobile device processor coupled to the mobile device memory unit, wherein the mobile device processor is configured with software instructions to perform steps comprising:
receiving a broadcasted dynamic pricing message via a mobile TV broadcast network indicating that viewing access to a broadcast program is available through dynamic pricing;
displaying the broadcasted dynamic pricing message;
receiving an inputted dynamic price offer for viewing access to the broadcast program;
transmitting the inputted dynamic price offer to a server within a mobile TV broadcast network via a unicast network; and
receiving decryption key information from the server within the mobile TV broadcast network via the unicast network that will enable access to the broadcast program.

44. The mobile device of claim 43, wherein the mobile device processor is configured with software instructions to perform further steps comprising:
receiving a counter offer price from the server within the mobile TV broadcast network;
displaying the received counter offer price;
receiving a user inputted response to the displayed counter offer price; and
transmitting a counter to the counter offer price to the server within the mobile TV broadcast network via the unicast network.

45. The mobile device of claim 44, wherein the counter to the counter offer price is equal to the counter offer price if the received user inputted response indicates an acceptance of the counter offer price.

46. The mobile device of claim 44, wherein the counter to the counter offer price is lower than the counter offer price if the received user inputted response indicates a rejection of the counter offer price.

47. A tangible storage medium having stored thereon processor-executable software instructions configured to cause a processor to perform steps comprising:
broadcasting a dynamic pricing message via a mobile TV broadcast network indicating that viewing access to a broadcast program is available through dynamic pricing;
receiving a dynamic price offer for viewing access to the broadcast program from a mobile device via a unicast network;
determining if the dynamic price offer is acceptable; and
transmitting decryption key information to the mobile device via the unicast network that will enable the mobile device to access the broadcast program if the dynamic price offer is determined to be acceptable.

48. The tangible storage medium of claim 47, wherein the tangible storage medium has processor-executable software instructions configured to cause a processor to perform further steps comprising:
transmitting a counter offer price to the mobile device if the dynamic price offer is determined to be not acceptable.

49. The tangible storage medium of claim 48, wherein the tangible storage medium has processor-executable software instructions configured to cause a processor to perform further steps comprising:
broadcasting a static pricing message via the broadcast network indicating that viewing access to a broadcast program is available through static pricing;
receiving a purchase request from the mobile device;
transmitting decryption key information to the mobile device via the unicast network that will enable the mobile device to access the broadcast program in response to receiving the purchase request; and
determining if a predetermined time threshold has been exceeded before broadcasting the dynamic pricing message.

50. The tangible storage medium of claim 49, wherein the tangible storage medium has processor-executable software instructions configured to cause a processor to perform further steps comprising:
accepting the dynamic price offer if it is greater than a minimum acceptable price, and wherein the minimum acceptable price is less than the static price offer.

51. The tangible storage medium of claim 49, wherein the tangible storage medium has processor-executable software instructions configured to cause a processor to perform further steps comprising:
accepting the dynamic price offer if it is greater than a minimum acceptable price, and wherein the minimum acceptable price is greater than the static price offer.

52. The tangible storage medium of claim 47, wherein the dynamic pricing is an auction process and wherein the dynamic price offer is a purchase request to access the broadcast program at a current asking price, and wherein the tangible storage medium has processor-executable software instructions configured to cause a processor to perform further steps comprising:
storing an identifier of the mobile device from which the purchase request is received;
determining if additional subscriptions are available for purchase;
closing the auction process if no additional subscriptions are available for purchase;
determining if the current asking price equals a reserve price;
decreasing the asking price if the current asking price exceeds the reserve price;
closing the auction process if the current asking price equals the reserve price; and
charging a user account associated with the stored identifier the current asking price when the auction process was closed before transmitting of the decryption keys.

53. The tangible storage medium of claim 47, wherein the dynamic pricing is an auction process and wherein the dynamic price offer is a bid for viewing access to the broadcast content program at a current announced asking price, and wherein the tangible storage medium has processor-executable software instructions configured to cause a processor to perform further steps comprising:
charging a user account the current asking price before said transmitting of the decryption keys;
determining if a time to adjust the current asking price has elapsed;
determining if the current asking price exceeds a reserve price;
adjusting the current asking price if the time to adjust the current asking price has elapsed and if the reserve price has not been met; and
closing the auction process if the current asking price does not exceed the reserve price.

54. The tangible storage medium of claim 53, wherein the tangible storage medium has processor-executable software instructions configured to cause a processor to perform further steps comprising:
adjusting the current asking price by increasing the current asking price.

55. The tangible storage medium of claim 53, wherein the tangible storage medium has processor-executable software instructions configured to cause a processor to perform further steps comprising:
adjusting the current asking price by decreasing the current asking price.

56. The tangible storage medium of claim 47, wherein the dynamic pricing is an auction process and wherein the dynamic price offer is a purchase request to access the broadcast program at a current asking price, and wherein the tangible storage medium has processor-executable software instructions configured to cause a processor to perform further steps comprising:
charging a user account the current asking price before transmitting of the decryption keys;
determining if additional subscriptions for accessing the broadcast program are available at the current asking price;
determining if the current asking price exceeds a reserve price;
adjusting the current asking price if no additional subscriptions for viewing access to the broadcast content are available at the current asking price and the current asking price exceeds the reserve price; and
closing the auction process if the current asking price does not exceed the reserve price.

57. The tangible storage medium of claim 56, wherein the tangible storage medium has processor-executable software instructions configured to cause a processor to perform further steps comprising:
adjusting the current asking price by increasing the current asking price.

58. The tangible storage medium of claim 56, wherein the tangible storage medium has processor-executable software instructions configured to cause a processor to perform further steps comprising:
adjusting the current asking price by decreasing the current asking price.

59. A tangible storage medium having stored thereon processor-executable software instructions configured to cause a processor to perform steps comprising:
receiving a broadcasted dynamic pricing message via a mobile TV broadcast network indicating that viewing access to a broadcast program is available through dynamic pricing;
displaying the broadcasted dynamic pricing message;
receiving an inputted dynamic price offer for viewing access to the broadcast program;
transmitting the inputted dynamic price offer to a server within a mobile TV broadcast network via a unicast network; and
receiving decryption key information from the server within the mobile TV broadcast network via the unicast network that will enable access to the broadcast program.

60. The tangible storage medium of claim 59, wherein the tangible storage medium has processor-executable software instructions configured to cause a processor to perform further steps comprising:
receiving a counter offer price from a server within a mobile TV broadcast network;
displaying the received counter offer price;
receiving a user inputted response to the displayed counter offer price; and
transmitting a counter to the counter offer price to the server within the mobile TV broadcast network via the unicast network.
